(19) United States
(12) Patent Application Publication
(10) Pub. No.: US 2011/0298909 A1
(43) Pub. Date: Dec. 8, 2011

(54) IMAGE PROCESSING APPARATUS, IMAGE PROCESSING METHOD, PROGRAM AND ELECTRONIC APPARATUS

(75) Inventors: Masahiro Ando, Kanagawa (JP); Hidetoshi Kabasawa, Saitama (JP); Takanori Shimizu, Tokyo (JP); Satoshi Mitani, Kanagawa (JP)

(73) Assignee: SONY CORPORATION, Tokyo (JP)

(21) Appl. No.: 13/109,433

(22) Filed: May 17, 2011

(30) Foreign Application Priority Data
Jun. 4, 2010 (JP) 2010-129413
Sep. 2, 2010 (JP) 2010-196803

(51) Int. Cl. G06K 9/00; H04N 7/18

(52) U.S. Cl. 348/77; 382/128; 348/E07.085

(57) ABSTRACT

An image processing apparatus detecting a skin area indicating human skin from an image, includes: an irradiating section irradiating an object with first and second wavelength light; a first generating section installed with an image sensor at least having a first light receiving element receiving the first wavelength light and a second light receiving element receiving the second wavelength light and generating a first mosaic image based on a reflected light from the object when the object is irradiated with the first and second wavelength lights incident to the image sensor; a second generating section generating a first image obtained by a first interpolation process and a second image obtained by a second interpolation process, in respective pixels forming the first mosaic image; and a detecting section detecting the skin area on the basis of the first and second images.

### CROSS REFERENCES TO RELATED APPLICATIONS

The present disclosure claims priority to Japanese Priority Patent Application JP 2010-129413 filed in the Japan Patent Office on Jun. 4, 2010 and Japanese Priority Patent Application JP 2010-196803 filed in the Japan Patent Office on Sep. 2, 2010, the entire contents of which are hereby incorporated by reference.

### BACKGROUND

The present disclosure relates to an image processing apparatus, an image processing method, a program and an electronic apparatus, and in particular, to an image processing apparatus, an image processing method, a program and an electronic apparatus which are suitably used in a case where a portion in which skin such as that of a human hand is exposed is detected on the basis of a captured image.

There has been proposed a skin detection technique in which an area (hereinafter, referred to as a “skin area”) where skin such as a face or hand is exposed is detected from an image obtained by image-capturing a person (for example, refer to Japanese Unexamined Patent Application Publication No. 2006-47067).

In this skin detection technique, a first image obtained by image-capturing an object (person) in the state of being irradiated with light having a wavelength λ1, and a second image obtained by image-capturing an object in the state of being irradiated with light having a wavelength λ2 which is longer than the wavelength λ1, are obtained. Further, an area in which a difference value obtained by subtracting a luminance value of the second image from a luminance value of the first image is larger than a predetermined threshold, is detected as a skin area.

The wavelengths λ1 and λ2 are determined depending on reflection characteristics of the human skin. That is, wavelengths λ1 and λ2 are determined so that the reflectances thereof are different from each other when the human skin is irradiated and the reflectances thereof are approximately the same when other parts (for example, hair, or clothes) other than the human skin are irradiated. Specifically, for example, the wavelength λ1 is 870 nm, and the wavelength λ2 is 950 nm.

### SUMMARY

Generally, in the skin detection technique, as shown in FIG. 34, the light of the wavelength λ1 and the light of the wavelength λ2 alternately irradiate an object and the object is image-captured the object to obtain a first image and a second image.

However, in this case, if the object moves, since the position of the object varies in the first image and the second image, it is difficult to perform the skin detection with high accuracy.

Accordingly, it is preferable to detect a skin area with high accuracy even in a case where the object moves.

According to an embodiment of the present disclosure, there is provided an image processing apparatus which detects a skin area indicating human skin from an image, including: an irradiating section which irradiates an object with light having a first wavelength and light of a second wavelength which is different from the first wavelength; a first generating section which is installed with an image sensor at least having a first light receiving element which receives the light having the first wavelength and a second light receiving element which receives the light having the second wavelength, and generates a first mosaic image on the basis of a reflected light from the object when the object is irradiated with the light of the first and second wavelengths, which is incident to the image sensor; a second generating section which generates a first image obtained by a first interpolation process based on a pixel value of a pixel corresponding to the first light receiving element and a second image obtained by a second interpolation process based on a pixel value of a pixel corresponding to the second light receiving element, in respective pixels which form the first mosaic image; and a detecting section which detects the skin area on the basis of the first and second images.

The first generating section may generate the first mosaic image on the basis of the reflected light from the object which is incident to the image sensor including the first and second light receiving elements, a third light receiving element which receives an R (red) component, a fourth light receiving element which receives a G (green) component and a fifth light receiving element which receives a B (blue) component.

The first generating section may generate a second mosaic image on the basis of the reflected light from the object when the object is not irradiated with the lights of the first and second wavelengths, which are incident to the image sensor, and the second generating section may generate an RGB image obtained by a third interpolation process based on a pixel value of a pixel corresponding to each of the third to fifth light receiving elements, in respective pixels which form the second mosaic image. Further, the image processing apparatus may include an adjusting section which adjusts parameters of the first generating section in a range where a skin detectable condition for detecting the skin area is satisfied, on the basis of the RGB image.

The first generating section may generate the first mosaic image by image-capturing the object according to a predetermined parameter, and the adjusting section may adjust the parameters of the first generating section in a range where the skin detectable condition that one of a luminance value of a pixel which forms the RGB image and a calculated value calculated on the basis of the luminance value becomes equal to or smaller than half a maximum luminance value which can be taken by the RGB image is satisfied.

The image processing apparatus may further include: a first incident restriction section which restricts incidence of light having wavelengths other than the first wavelength and transmits the light of the first wavelength; and a second incident restriction section which restricts incidence of light having wavelengths other than the second wavelength and transmits the light of the second wavelength. The first generating section may be installed with the image sensor which at least has the first light receiving element which receives the light of the first wavelength obtained through the first incident restriction section and the second light receiving element which receives the light of the second wavelength obtained through the second incident restriction section therein.

The first generating section may generate a second mosaic image on the basis of the reflected light from the object when the object is not irradiated with the lights of the first and second wavelengths, which are incident to the image sensor, and the second generating section may generate a third image obtained by a fourth interpolation process based on a pixel value of a pixel corresponding to the first light receiving element, in respective pixels which form the second mosaic image. Further, the detecting section may detect a predetermined area including pixels in which a pixel value of each pixel which forms the third image is equal to or larger than a predetermined threshold, among all areas in the third image.

The image processing apparatus may further include a control section which controls irradiation of the irradiating section, and the detecting section may detect the skin area on the basis of the first and second images generated by the second generating section in a case where the irradiation of the irradiating section is performed under the control of the control section, and may detect the predetermined area on the basis of the third image generated by the second generating section in a case where the irradiation of the irradiating section is not performed under the control of the control section.

According to another embodiment of the present disclosure, there is provided an image processing method in an image processing apparatus which includes an irradiating section, a first generating section which is installed with an image sensor at least having a first light receiving element which receives light having a first wavelength and a second light receiving element which receives light having a second wavelength which is different from the first wavelength, a second generating section, and a detecting section, and detects a skin area indicating human skin from an image, including: irradiating an object with the light of the first wavelength and the light of the second wavelength, by the irradiation section; generating a first mosaic image on the basis of a reflected light from the object when the object is irradiated with the light of the first and second wavelengths, which are incident to the image sensor, by the first generating section; generating a first image obtained by a first interpolation process based on a pixel value of a pixel corresponding to the first light receiving element and a second image obtained by a second interpolation process based on a pixel value of a pixel corresponding to the second light receiving element, in respective pixels which form the first mosaic image, by the second generating section; and detecting the skin area on the basis of the first and second images by the detecting section.

According to still another embodiment of the present disclosure, there is provided a program which allows a computer controlling an image processing apparatus which includes an irradiating section which irradiates an object with light having a first wavelength and light of a second wavelength which is different from the first wavelength and a first generating section which is installed with an image sensor at least having a first light receiving element which receives the light having the first wavelength and a second light receiving element which receives the light having the second wavelength, and generates a first mosaic image on the basis of a reflected light from the object when the object is irradiated with the light of the first and second wavelengths, which is incident to the image sensor, the image processing apparatus detecting a skin area indicating human skin from an image, to have functions including: a second generating section which generates a first image obtained by a first interpolation process based on a pixel value of a pixel corresponding to the first light receiving element and a second image obtained by a second interpolation process based on a pixel value of a pixel corresponding to the second light receiving element, in respective pixels which form the first mosaic image; and a detecting section which detects the skin area on the basis of the first and second images.

According to the above-described embodiments, the object is irradiated with the light having the first wavelength and the light of the second wavelength which is different from the first wavelength; the first mosaic image is generated on the basis of a reflected light from the object when the object is irradiated with the light of the first and second wavelengths, which is incident to the image sensor at least having the first light receiving element which receives the light having the first wavelength and the second light receiving element which receives the light having the second wavelength; the first image obtained by a first interpolation process based on the pixel value of the pixel corresponding to the first light receiving element, in the respective pixels which form the first mosaic image, is generated, and the second image obtained by the second interpolation process based on the pixel value of the pixel corresponding to the second light receiving element, in the respective pixels which form the first mosaic image, is generated; and the skin area is detected on the basis of the generated first and second images.

According to still another embodiment of the present disclosure, there is provided an electronic apparatus which detects a skin area indicating human skin from an image, including: an irradiating section which irradiates an object with light having a first wavelength and light of a second wavelength which is different from the first wavelength; a first generating section which is installed with an image sensor at least having a first light receiving element which receives the light having the first wavelength and a second light receiving element which receives the light having the second wavelength, and generates a first mosaic image on the basis of a reflected light from the object when the object is irradiated with the light of the first and second wavelengths, which is incident to the image sensor; a second generating section which generates a first image obtained by a first interpolation process based on a pixel value of a pixel corresponding to the first light receiving element and a second image obtained by a second interpolation process based on a pixel value of a pixel corresponding to the second light receiving element, in respective pixels which form the first mosaic image; a detecting section which detects the skin area on the basis of the first and second images; and an executing section which executes a process according to the detected skin area.

According to the above-described embodiment, the object is irradiated with the light having the first wavelength and the light of the second wavelength which is different from the first wavelength; the first mosaic image is generated on the basis of a reflected light from the object when the object is irradiated with the light of the first and second wavelengths, which is incident to the image sensor at least having the first light receiving element which receives the light having the first wavelength and the second light receiving element which receives the light having the second wavelength; the first image obtained by a first interpolation process based on the pixel value of the pixel corresponding to the first light receiving element, in the respective pixels which form the first mosaic image, is generated, and the second image obtained by the second interpolation process based on the pixel value of the pixel corresponding to the second light receiving element, in the respective pixels which form the first mosaic image, is generated; and the skin area is detected on the basis of the first and second images. Further, the process according to the detected skin area is executed.

According to still another embodiment of the present disclosure, there is provided an image processing apparatus which detects a skin area of human skin from an image, including: an irradiating section which irradiates an object with light having a first wavelength and light of a second wavelength which is different from the first wavelength; an image capturing section which image-captures the object, and generates a first image based on the light of the first wavelength and a second image based on the light of the second wavelength; and a detecting section which detects the skin area on the basis of the generated first and second images. Here, the irradiating section changes the luminance of the light of the first wavelength and the luminance of the light of the second wavelength according to a predetermined frequency to irradiate the object, and the image capturing section extracts a component, corresponding to the predetermined frequency, of an electric signal obtained by photoelectrically converting an optical image of the object, to generate the first and second images.

The irradiating section may alternately change the luminance of the light of the first wavelength and the luminance of the light of the second wavelength according to the predetermined frequency to irradiate the object, and the image capturing section may extract an alternating current component, corresponding to the predetermined frequency, of the electric signal obtained by photoelectrically converting the optical image of the object, to generate the first and second images.

The irradiating section may perform a process of alternately changing the luminance of the light of the first wavelength according to a first frequency to irradiate the object and a process of alternately changing the luminance of the light of the second wavelength according to a second frequency which is different from the first frequency to irradiate the object, at the same time, and the image capturing section may generate the first image by extracting the alternating current component, corresponding to the first frequency, of the electric signal obtained by photoelectrically converting the optical image of the object in the state of being irradiated with the light of the first and second wavelengths, and may generate the second image by extracting the alternating current component, corresponding to the second frequency, of the electric signal obtained by photoelectrically converting the optical image of the object.

The irradiating section may alternately perform a process of alternately changing the luminance of the light of the first wavelength according to a third frequency to irradiate the object and a process of alternately changing the luminance of the light of the second wavelength according to the third frequency to irradiate the object, and the image capturing section may generate the first image by extracting the alternating current component, corresponding to the third frequency, of the electric signal obtained by photoelectrically converting the optical image of the object in the state of being irradiated with the light of the first wavelength, and may generate the second image by extracting the alternating current component, corresponding to the third frequency, of the electric signal obtained by photoelectrically converting the optical image of the object in the state of being irradiated with the light of the second wavelength.

According to still another embodiment of the present disclosure, there is provided an image processing method in an image processing apparatus which includes an irradiating section which irradiates an object with light of a first wavelength and a second wavelength which is different from the first wavelength, an image capturing section which image-captures the object, and generates a first image based on the light of the first wavelength and a second image based on the light of the second wavelength, and a detecting section which detects a skin area on the basis of the generated first and second images, and detects the skin area indicating human skin from an image, including: changing the luminance of the light of the first wavelength and the luminance of the light of the second wavelength according to a predetermined frequency to irradiate the object, by the irradiating section; and generating the first and second image by extracting a component, corresponding to the predetermined frequency, of an electric signal obtained by photoelectrically converting an optical image of the object, by the image capturing section.

According to still another embodiment of the present disclosure, there is provided a program for controlling an image processing apparatus which includes an irradiating section which irradiates an object with light having a first wavelength and light of a second wavelength which is different from the first wavelength; an image capturing section which image-captures the object, and generates a first image based on the light of the first wavelength and a second image based on the light of the second wavelength; and a detecting section which detects a skin area on the basis of the generated first and second images, and detects the skin area of human skin from an image, the program allowing a computer of the image processing apparatus to execute processes including: changing the luminance of the light of the first wavelength and the luminance of the light of the second wavelength according to a predetermined frequency to irradiate the object, by controlling the irradiating section, and extracting a component, corresponding to the predetermined frequency, of an electric signal obtained by photoelectrically converting an optical image of the object, to generate the first and second images, by controlling the image capturing section.

In the above-described embodiments, the luminance of the light of the first wavelength and the luminance of the light of the second wavelength are changed according to the predetermined frequency to irradiate the object, and the component corresponding to the predetermined frequency of the electric signal obtained by photoelectrically converting the optical image of the object is extracted, to generate the first and second images.

According to still another embodiment of the present disclosure, there is provided an electronic apparatus which detects a skin area indicating human skin from an image, including: an irradiating section which irradiates an object with light having a first wavelength and light of a second wavelength which is different from the first wavelength; an image capturing section which image-captures the object, and generates a first image based on the light of the first wavelength and a second image based on the light of the second wavelength; a detecting section which detects the skin area on the basis of the generated first and second images, and an executing section which executes a process according to the detected skin area. Here, the irradiating section changes the luminance of the light of the first wavelength and the luminance of the light of the second wavelength according to a predetermined frequency to irradiate the object, and the image capturing section extracts a component, corresponding to the predetermined frequency, of the electric signal obtained by photoelectrically converting the optical image of the object, to generate the first and second images.

In the above-described embodiment, the luminance of the light of the first wavelength and the luminance of the light of the second wavelength are changed according to the predetermined frequency to irradiate the object, and the component corresponding to the predetermined frequency of the electric signal obtained by photoelectrically converting the optical image of the object is extracted, to generate the first and second images.

According to the above-described embodiments, it is possible to detect the skin area with high accuracy.

Additional features and advantages are described herein, and will be apparent from the following Detailed Description and the figures.

### BRIEF DESCRIPTION OF THE FIGURES

FIG. 1 is a block diagram illustrating an example of a configuration of an information processing system according to the present disclosure;

FIG. 2 is a diagram illustrating an example of spectral reflection characteristics for human skin;

FIG. 3 is a diagram illustrating a first example of a filter board installed in an image sensor;

FIG. 4 is a diagram illustrating an example of light transmission characteristics in the filter board in FIG. 3;

FIG. 5 is a diagram illustrating an example of a configuration of an image processing apparatus;

FIG. 6 is a diagram illustrating details of a process performed by a calculating section and a binarizing section;

FIG. 7 is a flowchart illustrating a skin detection process;

FIG. 8 is a diagram illustrating a second example of a filter board installed in an image sensor;

FIG. 9 is a diagram illustrating an example of light transmission characteristics in the filter board in FIG. 8;

FIG. 10 is a diagram illustrating a first example of a histogram in an outside light image;

FIG. 11 is a flowchart illustrating a skin detection adjustment process;

FIG. 12 is a diagram illustrating a second example of a histogram in an outside light image;

FIG. 13 is a diagram illustrating a third example of a histogram in an outside light image;

FIG. 14 is a diagram illustrating an example of transmission characteristics of R, G and B filters in the related art;

FIG. 15 is a diagram illustrating an example of transmission characteristics of an IR cut filter in the related art;

FIG. 16 is a diagram illustrating an example of transmission characteristics obtained in a case where the IR cut filter in the related art is installed in the R, G and B filters in the related art;

FIG. 17 is a diagram illustrating a third example of a filter board installed in an image sensor;

FIG. 18 is a diagram illustrating an example of a filter board arranged according to the Bayer arrangement;

FIG. 19 is a diagram illustrating an example of an IR cut filter in which a λ1 filter and a λ2 filter are installed;

FIG. 20 is a diagram illustrating a fourth example of a filter board installed in an image sensor;

FIG. 21 is a diagram illustrating an example of a small module according to the present disclosure;

FIG. 22 is a diagram illustrating an example of a television set in which a small module is installed;

FIG. 23 is a flowchart illustrating an LED detection process;

FIG. 24 is a flowchart illustrating an LED detection adjustment process;

FIGS. 25A to 25D are diagrams illustrating an example of an image displayed on a display;

FIG. 26 is a diagram illustrating timings of irradiation and image-capturing not in association with luminance variation corresponding to a first embodiment;

FIG. 27 is a diagram illustrating timings of irradiation and image-capturing in association with luminance variation corresponding to a fourth embodiment;

FIG. 28 is a block diagram illustrating an example of a configuration of a CMOS image sensor according to the fourth embodiment;

FIG. 29 is a flowchart illustrating a generation process of a λ1 image and a λ2 image according to the fourth embodiment;

FIG. 30 is a diagram illustrating timings of irradiation and image-capturing in association with luminance variation corresponding to a fifth embodiment;

FIG. 31 is a block diagram illustrating an example of a configuration of a CMOS image sensor according to the fifth embodiment;

FIG. 32 is a flowchart illustrating a generation process of a λ1 image and a λ2 image according to the fifth embodiment;

FIG. 33 is a block diagram illustrating an example of a configuration of a computer; and

FIG. 34 is a diagram illustrating timings of irradiation and image-capturing in a skin detection technique in the related art.

### DETAILED DESCRIPTION

Embodiments of the present application will be described below in detail with reference to the drawings.

1. First embodiment (an example in a case where a λ1 image and a λ2 image are generated from a mosaic image)

2. Second embodiment (an example in a case where a gain of a camera 22 is adjusted on the basis of an outside light image)

3. Third embodiment (an example of a television set which detects an LED position)

4. Fourth embodiment (an example in a case where the luminance of light having a wavelength λ1 and the luminance of light having a wavelength λ2 are alternately changed at different frequencies for simultaneous irradiation)

5. Fifth embodiment (an example in a case where the luminance of light having a wavelength λ1 and the luminance of light having a wavelength λ2 are alternately changed at the same frequency for alternate irradiation)

### 1. First Embodiment

Configuration Example of an Information Processing System 1

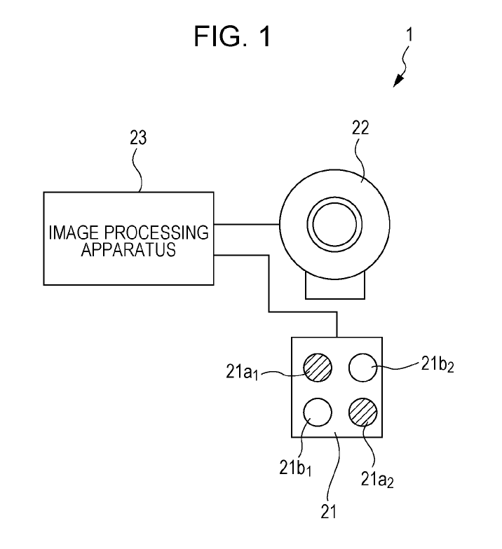

FIG. 1 is a diagram illustrating an example of a configuration of an information processing system 1 according to an embodiment of the present disclosure.

The information processing system 1 performs a predetermined process according to gestures (or postures) using hands of a user, and includes a light emitting apparatus 21, a camera 22 and an image processing apparatus 23.

In order to allow the information processing system 1 to perform the predetermined process, a user changes shapes of their hands or moves their hands in front of a lens surface of the camera 22.

At this time, the information processing system 1 recognizes the shapes or movements of the user's hands and performs the predetermined process according to the recognition result.

In the first embodiment, it is assumed that the user changes the shapes of their hands in front of the lens surface of the camera 22 and the user positions their hands to a position closer to the lens surface of the camera 22 than their face, chest and the like and perform actions such as changing the shapes of their hands or moving their hands.

The light emitting apparatus 21 includes an LED (Light Emitting Diode) 21a1 and an LED 21a2 which emit light of a wavelength λ1 (for example, a near-infrared light of 870 [nm]), and an LED 21b1 and an LED 21b2 which emit light of a wavelength λ2 (for example, a near-infrared light of 950 [nm]) which is different from the wavelength λ1.

Hereinafter, in a case where it is not necessary to distinguish between the LED 21a1 and the LED 21a2, it is simply referred to as an “LED 21a”, and in a case where it is not necessary to distinguish between the LED 21b1 and the LED 21b2, it is simply referred to as an “LED 21b”. The number of the LEDs 21a and the number of the LEDs 21b are not limited to two, respectively.

The light emitting apparatus 21 allows the LED 21a and the LED 21b to emit light, for example, at the same time, under the control of the image processing apparatus 23.

In a case where an object which has the same reflectance for the wavelengths λ1 and λ2 (for example, a mirror surface or the like having a reflectance of 100[%]) is irradiated with either of the light of the wavelengths λ1 and λ2, the light outputs of the LED 21a and the LED 21b are adjusted so that luminance values of corresponding pixels in images obtained by the image capturing of the camera 22 are the same.

Further, in the combination of the wavelength λ1 in the LED 21a and the wavelength λ2 in the LED 21b, for example, a reflectance when human skin is irradiated with the light of the wavelength λ1 is larger than a reflectance when human skin is irradiated with the light of the wavelength λ2, and a reflectance when something other than human skin is irradiated with the light is barely changed. That is, the combination is determined on the basis of spectral reflection characteristics for human skin.

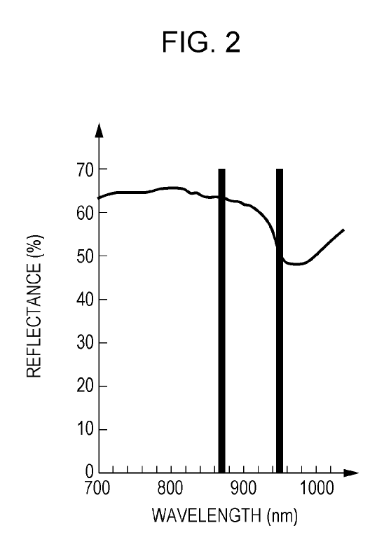

Next, FIG. 2 illustrates the spectral reflection characteristics for human skin.

The spectral reflection characteristics have generality irrespective of difference in color (race differences) or states (sunburn or the like) or the like of human skin.

In FIG. 2, the transverse axis represents a wavelength of an irradiation light irradiating human skin, and the longitudinal axis represents a reflectance of the irradiation light irradiating human skin.

It is known that the reflectance of the irradiation light irradiating human skin has a peak around a wavelength of 800 [nm], rapidly decreases from a wavelength of about 900 [nm], has a minimum value around a wavelength of 1000 [nm], and then increases again.

Specifically, for example, as shown in FIG. 2, a reflectance of the reflection light obtained by irradiating human skin with the light of the wavelength of 870 [nm] is about 63[%], and a reflectance of the reflection light obtained by irradiating human skin with the light of the wavelength of 950 [nm] is about 50[%].

This is unique to human skin. In the case of objects other than human skin (for example, hair, clothes and the like), change in the reflectance is mostly smooth around 800 to 1000 [nm].

In the first embodiment, in terms of the spectral reflection characteristics, for example, a combination in which the wavelength λ1 is 870 [nm] and the wavelength λ2 is 950 [nm] is employed as the combination of the wavelength λ1 and the wavelength λ2. In this combination, a difference between reflectances for human skin becomes relatively large, and a difference between reflectances in portions other than human skin becomes relatively small.

The combination of the wavelength λ1 and the wavelength λ2 is not limited to the wavelength of 870 [nm] and the wavelength of 950 [nm], and for example, as long as the combination satisfies the following relationship, any combination may be employed.

λ1<λ2

630 [nm]≦λ1≦1000 [nm]

900 [nm]≦λ2≦1100 [nm]

Returning to FIG. 1, the camera 22 includes an image sensor such as a CCD or CMOS in addition to the lens.

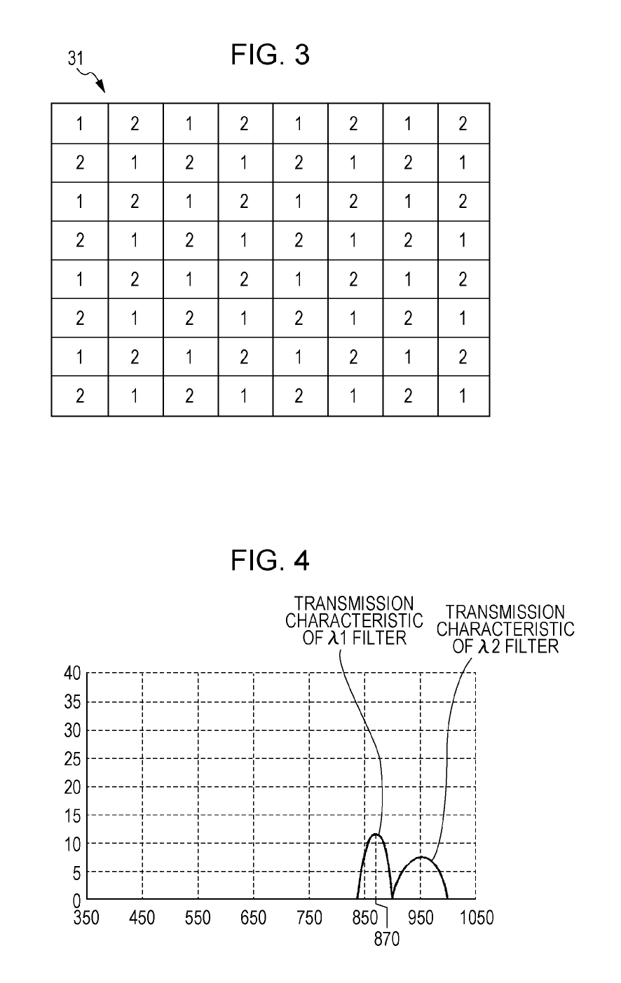

As shown in FIG. 3, a filter board 31 in which a λ1 filter (corresponding to “1” in FIG. 3) and a λ2 filter (corresponding to “2” in FIG. 3) are checkerwise arranged is installed on a front surface of the image sensor of the camera 22.

As shown in FIG. 4, the λ1 filter has a transmission characteristic of transmitting light (light of the wavelength λ1) in which a peak wavelength of a light emitting spectrum is λ1 (here, λ1=870 [nm]). Further, the λ2 filter has a transmission characteristic of transmitting light (light of the wavelength λ2) in which a peak wavelength of a light emitting spectrum is λ2 (here, λ1=950 [nm]).

Thus, the camera 22 receives only the light of the wavelength λ1 and the light of the wavelength λ2 in a plurality of light receiving elements which forms the image sensor. Further, among the plurality of light receiving elements which forms the image sensor, the light receiving element in which the λ1 filter is installed photoelectrically converts the received light of the wavelength λ1 to obtain pixel value×(λ1) as a pixel value of a pixel corresponding to the light receiving element. Further, among the plurality of light receiving elements which forms the image sensor, the light receiving element in which the λ2 filter is installed photoelectrically converts the received light of the wavelength λ2 to obtain pixel value×(λ2) as a pixel value of a pixel corresponding to the light receiving element.

That is, the image sensor of the camera 22 generates a mosaic image in which the pixels having pixel value×(λ1) obtained by photoelectrically converting the received light of the wavelength λ1 and the pixels having pixel value×(λ2) obtained by photoelectrically converting the received light of the wavelength λ2 are checkerwise arranged.

Then, the camera 22 performs a λ1 interpolation process in which pixel value×(λ1) obtained in a case where the light of the wavelength λ1 is received is interpolated in the pixel corresponding to the light receiving element in which the λ2 filter is installed, using pixel value×(λ1) of the pixel corresponding to the light receiving element in which the λ1 filter is installed, among the pixel values of the respective pixels which form the mosaic image, and supplies a λ1 image obtained as a result to the image processing apparatus 23.

Further, the camera 22 performs a λ2 interpolation process in which pixel value×(λ2) obtained in a case where the light of the wavelength λ2 is received is interpolated in the pixel corresponding to the light receiving element in which the λ1 filter is installed, using pixel value×(λ2) of the pixel corresponding to the light receiving element in which the λ2 filter is installed, among the pixel values of the respective pixels which form the mosaic image, and supplies a λ2 image obtained as a result to the image processing apparatus 23.

The image processing apparatus 23 calculates a difference obtained by subtracting, from the pixel values (for example, luminance value) of the pixels which form the λ1 image, the pixel values of the pixels which form the λ2 image corresponding to the pixels which form the λ1 image, on the basis of the λ1 image and the λ2 image supplied from the camera 22.

Then, the image processing apparatus 23 detects a skin area on the λ1 image (or λ2 image) on the basis of the calculated difference. The image processing apparatus 23 recognizes the shapes or the like of the user's hands on the basis of the detected skin area, and performs a predetermined process according to the recognition result.

Configuration Example of the Image Processing Apparatus 23

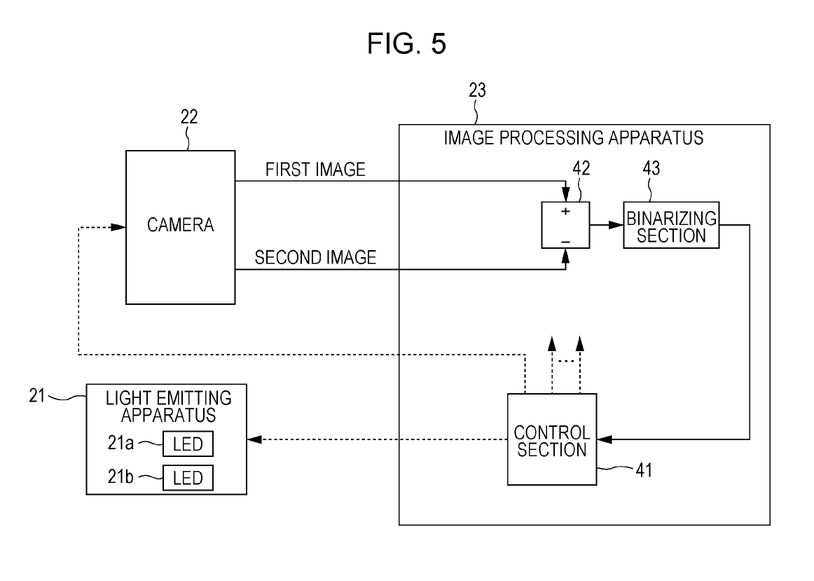

FIG. 5 illustrates a configuration example of the image processing apparatus 23.

The image processing apparatus 23 includes a control section 41, a calculating section 42 and a binarizing section 43.

The control section 41 controls an image-capturing timing and an image-capturing time of the camera 22, and a light emitting timing and a light emitting time of the light emitting apparatus 23. Further, for example, the control section 41 controls the calculating section 42 and the binarizing section 43.

The calculating section 42 performs a smoothing process using an LPF (Low Pass Filter) for the λ1 image and the λ2 image from the camera 22. Then, the calculating section 42 calculates the difference between the λ1 image and the λ2 image after the smoothing process, and supplies a difference image formed by pixels in which the calculated difference is used as a pixel value to the binarizing section 43.

In this respect, the camera 22 may supply the generated mosaic image to the calculating section 42, and the calculating section 42 may generate the λ1 image by performing the λ1 interpolation process for the mosaic image from the camera 22 and may generate the λ2 image by performing the λ2 interpolation process for the mosaic image from the camera 22. Then, the calculating section 42 may perform the smoothing process or the like using the LPF for the calculated λ1 image and λ2 image.

The binarizing section 43 binarizes the difference image from the calculating section 42, detects the skin area on the λ1 image (or λ2 image) on the basis of the binarized skin image obtained as a result, and supplies the detection result to the control section 41.

Here, the pixel values of the pixels which form a difference image 63 may also be normalized (divided) by the luminance values of the corresponding pixels among pixels which form a λ1 image 61, for binarization. Further, the binarizing section 43 may also normalize the difference image 63 using a λ2 image 62 instead of the λ1 image 61, for binarization.

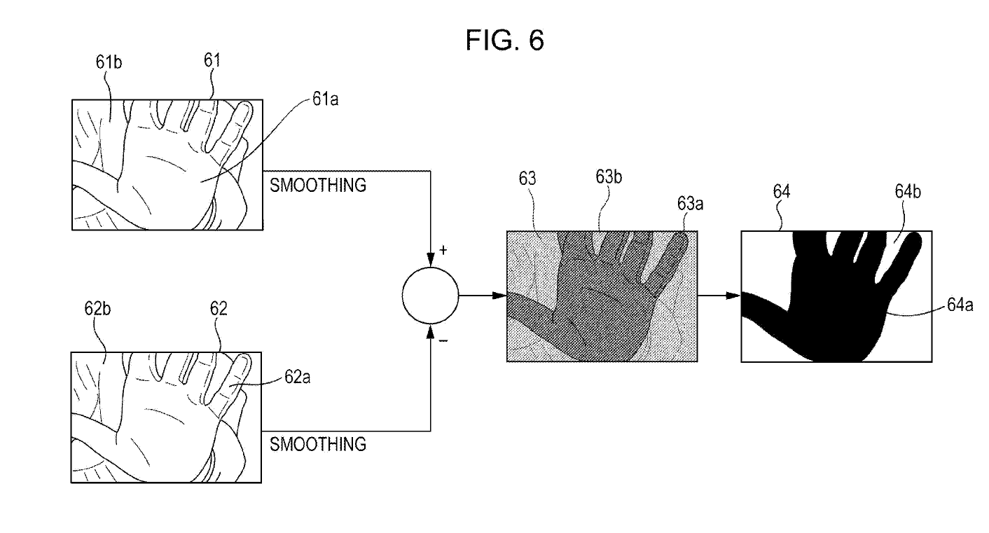

FIG. 6 illustrates details of the process performed by the calculating section 42 and the binarizing section 43.

The λ1 image 61 including a skin area 61a and a non-skin area 61b (area other than the skin area 61a) and the λ2 image 62 including a skin area 62a and a non-skin area 62b (area other than the skin area 62a) are supplied to the calculating section 42 from the camera 22.

The calculating section 42 performs the smoothing process using the LPF for the λ1 image 61 and the λ2 image 62 supplied from the camera 22. Then, the calculating section 42 calculates the difference between the pixel values (for example, luminance values) of corresponding pixels in the λ1 image 61 after the smoothing process and the λ2 image 62 after the smoothing process, generates the difference image 63 in which the difference is used as a pixel value, and then supplies the result to the binarizing section 43.

The binarizing section 43 performs the binarization in which pixel values which are equal to or larger than a binarization threshold used for the binarization are set to “1” and pixel values which are smaller than the binarization threshold are set to “0”, among the pixel values of the pixels which form the difference image 63, for the difference image 63 from the calculating section 42.

Here, since a skin area 63a in the difference image 63 includes pixels in which the difference between the skin area 61a and the skin area 62a is used as a pixel value, the pixel values of the pixels which form the skin area 63a are relatively large.

Further, since a non-skin area 63b in the difference image 63 includes pixels in which the difference between the non-skin area 61b and the non-skin area 62b is used as a pixel value, the pixel values of the pixels which form the non-skin area 63b are relatively small.

Accordingly, the difference image 63 is converted into a binarized skin image 64 including a skin area 64a in which the pixel values of the pixels which form the skin area 63a are set to “1” and a non-skin area 64b in which the pixel values of the pixels which form the non-skin area 63b are set to “0”, by the binarization performed by the binarizing section 43.

Further, the binarizing section 43 supplies the skin area 64a on the binarized skin area 64 obtained by the binarization to the control section 41.

Details of a Skin Detection Process Performed by the Information Processing System 1

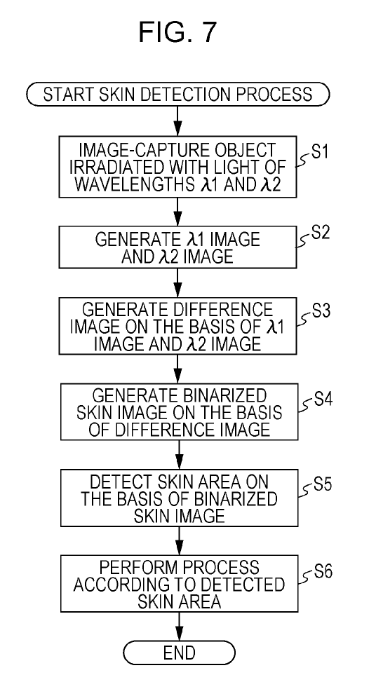

Next, a skin detection process performed by the information processing system 1 will be described with reference to a flowchart in FIG. 7.

In step S1, the LED 21a and the LED 21b irradiate an object at the same irradiation timing under the control of the control section 41. The camera 22 receives light reflected from the object irradiated with the light of the wavelength λ1 from the LED 21a and the light of the wavelength λ2 from the LED 21b, and photoelectrically converts the received reflection light to thereby generate a mosaic image.

In step S2, the camera 22 performs the λ1 interpolation process on the basis of the generated mosaic image, and supplies the λ1 image obtained as a result to the calculating section 42. Further, the camera 22 performs the λ2 interpolation process on the basis of the generated mosaic image, and supplies the λ2 image obtained as a result to the calculating section 42.

In step S3, the calculating section 42 performs the smoothing process using the LPF for the λ1 image and the λ2 image from the camera 22. Then, the calculating section 42 calculates the difference between the λ1 image and the λ2 image after the smoothing process, and supplies the difference image including pixels in which the calculated difference is used as a pixel value to the binarizing section 43.

In step S4, the binarizing section 43 generates the binarized skin image by binarizing the difference image from the calculating section 42.

In step S5, the binarizing section 43 detects the skin area on the λ1 image (or λ2 image) on the basis of the generated binarized skin image, and then supplies the detection result to the control section 41.

In step S6, the control section 41 performs a process according to the detection result from the binarizing section 43, that is, a process of changing a channel such as a television set (not shown) according to shapes of the skin area from the binarizing section 43, for example. In this way, the skin detection process is terminated.

As described above, the λ1 image and the λ2 image used for the skin area detection are generated from the mosaic image obtained by installing the filter board 31 shown in FIG. 3 on the front surface of the image sensor of the camera 22, in the skin detection process.

Thus, it is not necessary to allow the LED 21a and the LED 21b to emit light at different timings in the skin detection process, and thus, it is easy to control the LED 21a and the LED 21b.

Further, for example, in a case where the LED 21a and the LED 21b emit light at different timings, it is possible to prevent the position of the object in the λ1 image and the position of the object in the λ2 image from being misaligned due to movement of the object.

Further, for example, it is possible to prevent the positions of the object in the λ1 image and the λ2 image from being misaligned due to disparity, as in a case where a first camera in which a first transmission filter which transmits only the light of the wavelength λ1 is installed in order to generate the λ1 image by receiving only the light of the wavelength λ1 and a second camera in which a second transmission filter which transmits only the light of the wavelength λ2 is installed in order to generate the λ2 image by receiving only the light of the wavelength λ2 are used.

Thus, in the skin detection process, since the positions of the object in the λ1 image and the λ2 image are not misaligned, it is possible to prevent accuracy of the skin detection from being deteriorated.

### 2. Second Embodiment

However, in a case where the filter board 31 shown in FIG. 3 is used, the λ1 image having a grayscale corresponding to the intensity of the light of the received wavelength λ1 and the λ2 image having a grayscale corresponding to the intensity of the light of the received wavelength λ2 are obtained, but it is difficult to obtain an RGB image in which each pixel includes an R (red) value, a G (green) value and a B (blue) value.

Thus, as the filter board installed on the front surface of the image sensor of the camera 22, a filter board 71 may be employed in which an R filter which transmits only an R component, a G filter which transmits only a G component and a B filter which transmits only a B component are installed, in addition to the λ1 filter and the λ2 filter.

An example of an arrangement through filter board

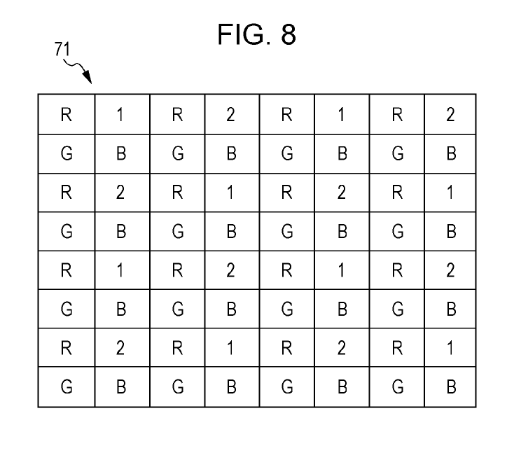

FIG. 8 illustrates an example of the filter board 71 in which the λ1 filter, the λ2 filter, the R filter, the G filter and the B filter are installed.

In the filter board 71, as shown in FIG. 8, the R filter (“R” in FIG. 8) is arranged every two pixels in odd rows, and the λ1 filter and the λ2 filter are alternately arranged between the R filters. Further, in the filter 71, as shown in FIG. 8, the G filter (“G” in FIG. 8) and the B filter (“B” in FIG. 8) are alternately arranged in even rows.

That is, the filter board 71 is obtained by replacing the G filter arranged in the odd rows in the R filter, the G filter and the B filter which are arranged in the so-called Bayer arrangement with the λ1 filter or the λ2 filter.

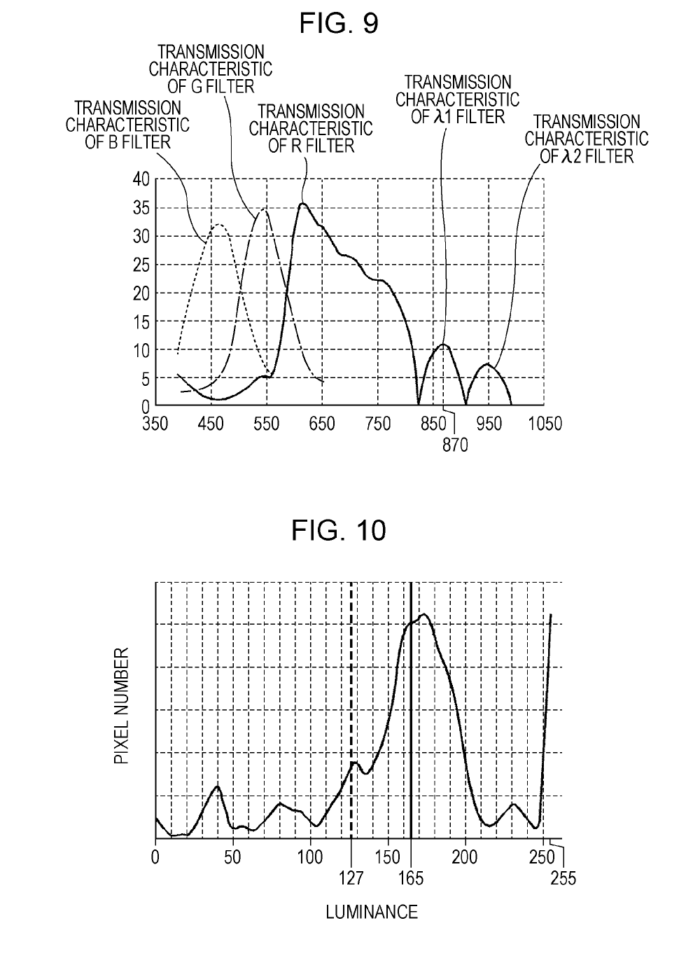

FIG. 9 is a diagram illustrating an example of transmission characteristics of each filter which forms the filter board 71 shown in FIG. 8. In FIG. 9, the transverse axis represents a wavelength, and the longitudinal axis represents quantum efficiency.

In the camera 22, if the filter board 71 as shown in FIG. 8 is used, an RGB interpolation process is performed for the mosaic image generated on the basis of the reflection light received through the filter board 71, to thereby make it possible to generate the RGB image.

That is, for example, the camera 22 interpolates the pixel value obtained in a case where the R component is received, in the pixels corresponding to the light receiving elements in which the filters other than the R filter are installed, using the pixel value of the pixel corresponding to the light receiving element in which the R filter is installed, among the pixel values of the respective pixels which form the generated mosaic image.

Further, for example, the camera 22 interpolates the pixel value obtained in a case where the G component is received, in the pixels corresponding to the light receiving elements in which the filters other than the G filter are installed, using the pixel value of the pixel corresponding to the light receiving element in which the G filter is installed, among the pixel values of the respective pixels which form the generated mosaic image.

Further, for example, the camera 22 interpolates the pixel value obtained in a case where the B component is received, in the pixels corresponding to the light receiving elements in which the filters other than the B filter are installed, using the pixel value of the pixel corresponding to the light receiving element in which the B filter is installed, among the pixel values of the respective pixels which form the generated mosaic image.

Thus, the camera 22 generates the RGB image having the R value, the G value and the B value in each pixel.

The λ1 image and the λ2 image are generated from the mosaic image in a similar way to the case where the filter board 31 is installed.

Further, in the image processing apparatus 23, for example, a gain or the like of the camera 22 is adjusted on the basis of the RGB image generated according to the mosaic image obtained by the image capturing of the camera 22, in a state where the LED 21a and the LED 21b are turned off, and thus, it is possible to detect the skin with high accuracy without being affected by an outside light such as sunlight or a fluorescent light.

That is, for example, the camera 22 supplies the RGB image obtained in the state where the LED 21a and the LED 21b are turned off, to the control section 41.

Further, the control section 41 performs a skin detection adjustment process of adjusting the gain of the camera 22 and the amount of irradiation light of the LED 21a or the LED 21b in the light emitting apparatus 21, on the basis of the RGB image from the camera 22.

The control section 41 generates a histogram of the pixel values (for example, luminance values) of pixels which form an outside light image, with respect to the outside light image, using the RGB image from the camera 22 as the outside light image, and adjusts the gain of the camera 22 on the basis of the generated histogram.

That is, for example, the control section 41 adjusts the gain of the camera 22 in a range where the skin area can be detected with high accuracy, even in the case of noise generated in the λ1 image and the λ2 image, variation in the amount of irradiation light of the LED 21a and the LED 21b, or the like, without saturation (whiteout or the like) of the camera 22, on the basis of the generated histogram.

FIG. 10 illustrates an example of the histogram generated by the control section 41.

In FIG. 10, the transverse axis represents a luminance value and the longitudinal axis represents the total number of pixels having the luminance value in the transverse axis in the outside light image. Here, it is assumed that the camera 22 generates the outside light image in which the luminance value is expressed as a grayscale of 28 (=256). Accordingly, the transverse axis expresses the luminance value ranging from 0 to 255.

The control section 41 generates the histogram as shown in FIG. 10 on the basis of the outside light image from the camera 22, and calculates an average luminance value which expresses an average value of the luminance values of the pixels which form the outside light image on the basis of the generated histogram.

Then, for example, the control section 41 adjusts the gain of the camera 22, in the range where the skin area can be detected with high accuracy, specifically, in a range where the calculated average luminance value becomes equal to or smaller than half the maximum luminance value which can be taken by the outside light image, on the basis of the calculated average luminance value.

Preferably, the control section 41 adjusts the gain of the camera 22 so that the calculated average luminance value becomes a luminance value which is half the maximum luminance value which can be taken by the outside light image.

That is, for example, as shown in FIG. 10, in a case where an average luminance value 165 (indicated by a thick vertical line in FIG. 10) is calculated, the control section 41 adjusts the gain so that the average luminance value 165 becomes a luminance value 127 (indicated by a thick dotted line in FIG. 10) which is half a maximum luminance value 255 which can be taken by the outside light image.

After the gain is adjusted, the control section 41 controls the LED 21a and the LED 21b of the light emitting apparatus 21 to allow the LED 21a and the LED 21b to emit light at the same time. Further, the control section 41 controls the camera 22 and performs image capturing for the object through the camera 22, and supplies the λ1 image and the λ2 image output from the camera 22 to the calculating section 42.

Further, the control section 41 controls the calculating section 42 and the binarizing section 43 to detect the skin area based on the λ1 image and the λ2 image.

In a case where a detection result indicating that the skin area can be detected is obtained as the detection result of the skin area from the binarizing section 43, the control section 41 performs the adjustment of reducing the amount of the irradiation light of the LED 21a and the LED 21b to obtain a necessary minimum amount of irradiation light in which the skin area can be detected with high accuracy.

Further, since the skin area is not detected as the amount of the irradiation light of the LED 21a and the LED 21b is excessively reduced, in a case where the detection result indicating that the skin area is not detected is obtained as the detection result of the skin area from the binarizing section 43, the control section 41 adjusts the gain of the camera 22 to be larger than the current gain so that the skin area can be detected.

In order to perform the process based on the detection result of the skin area after the gain of the camera 22 and the amount of the irradiation light of the LED 21a and the LED 21b are adjusted, the control section 41 controls the calculating section 42 and the binarizing section 43 to perform the detection of the skin area based on the λ1 image and the λ2 image.

Then, the control section 41 performs the process based on the detection result of the skin area from the binarizing section 43. That is, for example, the control section 41 recognizes a user's gesture or posture on the basis of the detection result from the binarizing section 43, and performs a process corresponding to the recognized gesture or the like.

Details of the Skin Detection Adjustment Process Performed by the Image Processing Apparatus 23

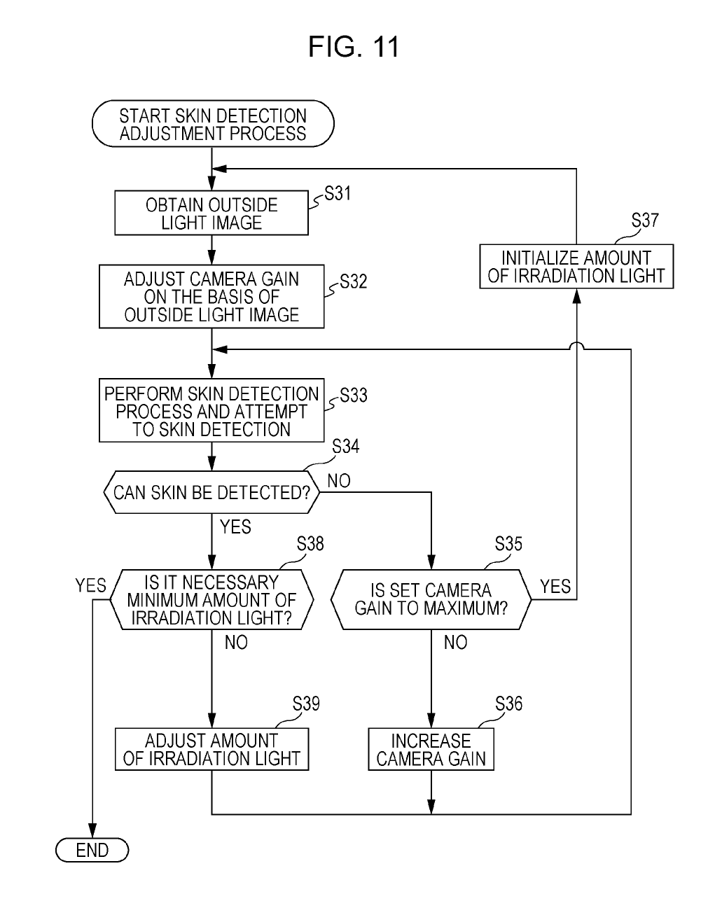

Next, the skin detection adjustment process performed by the image processing apparatus 23 will be described with reference to a flowchart in FIG. 11.

In step S31, the control section 41 controls the light emitting apparatus 21 and the camera 22, performs the image capturing of the object through the camera 22 in the state where the LED 21a and the LED 21b of the light emitting apparatus 21 are turned off, and obtains the mosaic image obtained by the image capturing.

Then, the camera 22 performs the RGB interpolation process using the pixel values having any one of the R value, the G value and the B value among the pixel values of the respective pixels which form the mosaic image, for the obtained mosaic image, and supplies the RGB image obtained as a result, to the control section 41 as the outside light image.

In step S32, for example, the control section 41 generates the histogram on the basis of the outside light image from the camera 22, and calculates the average luminance value of the luminance values of the pixels which form the outside light image on the basis of the generated histogram.

Then, the control section 41 adjusts the gain of the camera 22 so that the calculated average luminance value becomes equal to or smaller than half the maximum luminance value which can be taken by the outside light image, on the basis of the calculated average luminance value.

Preferably, the control section 41 adjusts the gain of the camera 22 so that the calculated average luminance value becomes a luminance value which is half the maximum luminance value which can be taken by the outside light image.

In step S33, the skin detection process in FIG. 7 is performed. Specifically, for example, the camera 22 performs the image capturing of the object in the state where the LED 21a and the LED 21b are turned on. Then, the camera 22 supplies the λ1 image obtained by performing the λ1 interpolation process and the λ2 image obtained by performing the λ2 interpolation process, for the mosaic image obtained as the result, to the calculating section 42.

The calculating section 42 generates a difference image on the basis of the λ1 image and the λ2 image from the camera 22, and supplies it to the binarizing section 43. The binarizing section 43 converts the difference image from the calculating section 42 into a binarized skin image, and tests detection of the skin area on the basis of the binarized skin image after conversion.

Then, the binarizing section 43 supplies the detection result indicating whether the skin area can be detected to the control section 41.

In step S34, the control section 41 determines whether the skin area can be detected on the basis of the detection result from the binarizing section 43, and in a case where it is determined that the skin area can not be detected, the process proceeds to step S35.

In step S35, the control section 41 determines whether the gain adjusted in step S32 is an adjustable maximum gain, and in a case where it is determined that it is not the maximum gain, the process proceeds to step S36.

In step S36, the control section 41 controls the camera 22 to adjust the gain of the camera 22 to become larger than the gain which is currently set, and then the process returns to step S33. Then, the calculating section 42 obtains the λ1 image and the λ2 image which are newly supplied by the image capturing of the camera 22 after the gain is adjusted, and then the same process is performed.

Further, in a case where it is determined in step S35 that the gain adjusted in step S32 is the adjustable maximum gain, since the control section 41 does not adjust the gain to be larger than the maximum gain, the process proceeds to step S37.

In step S37, the control section 41 controls the light emitting apparatus 21 to initialize the amount of the irradiation light of the LED 21a and the LED 21b at a predetermined value, and then the process returns to step S31. Then, the control section 41 re-performs the skin detection adjustment process.

That is, in a case where the process proceeds to step S37, since it is considered that the skin area is not detected as the amount of the irradiation light of the LED 21a and the LED 21b is excessively reduced in step S39 (which will be described later), the amount of the irradiation light of the LED 21a and the LED 21b is initialized as the predetermined value to re-perform the skin detection adjustment process.

On the other hand, in a case where it is determined in step S34 that the control section 41 can detect the skin area on the basis of the detection result from the binarizing section 43, the process proceeds to step S38. In this case, the binarizing section 43 supplies the detection result indicating that the skin area can be detected, the generated binarized skin image, and the difference image from the calculating section 42 to the control section 41.

It step S38, the control section 41 determines whether the amount of the irradiation light of the LED 21a and the LED 21b is the necessary minimum amount of irradiation light for detecting the skin area, on the basis of the binarized skin image and the difference image from the binarizing section 43.

That is, for example, the control section 41 extracts the skin area corresponding to the skin area (for example, an area including pixels in which the pixel value is “1”) on the binarized skin image, from the difference image from the binarizing section 43, on the basis of the binarized skin image from the binarizing section 43.

Further, in a case where the pixel values of the pixels which form the skin area on the extracted difference image are nearly the same as a skin detectable value (a value sufficiently larger than the pixel values of the pixels which form the non-skin area on the difference image from the calculating section 42), the control section 41 determines that the amount of the irradiation light of the LED 21a and the LED 21b is the necessary minimum amount of irradiation light, and in a case where the pixel values of the pixels which form the skin area on the extracted difference image are larger than the skin detectable value, the control section 41 determines that the amount of the irradiation light of the LED 21a and the LED 21b is not the necessary minimum amount of irradiation light.

Specifically, for example, in a case where the average value of the pixel values of the pixels which form the skin area on the extracted difference image is almost the same as the skin detectable value, the control section 41 determines that the amount of the irradiation light of the LED 21a and the LED 21b is the necessary minimum amount of irradiation light, and in a case where the average value of the pixel values of the pixels which form the skin area on the extracted difference image is larger than the skin detectable value, the control section 41 determines that the amount of the irradiation light of the LED 21a and the LED 21b is not the necessary minimum amount of the irradiation light.

In step S38, in a case where the control section 41 determines that the amount of the irradiation light of the LED 21a and the LED 21b is not the necessary minimum amount of irradiation light for detection of the skin area, the process proceeds to step S39.

In step S39, the control section 41 controls the light emitting apparatus 21 to perform the adjustment of reducing the amount of the irradiation light of the LED 21a and the LED 21b, to become the necessary minimum amount of irradiation light for detection of the skin area.

That is, for example, the control section 41 adjusts the amount of the irradiation light of the LED 21a and the LED 21b so that the luminance value of the pixels which form the skin area on the λ1 image and the λ2 image obtained by the image capturing of the camera 22 becomes a necessary minimum luminance value in which the skin area can be detected with high accuracy, that is, so that the average value of the pixel values of the pixels which form the skin area on the difference image becomes nearly the same as the skin detectable value.

After the process in step S39 is terminated, the control section 41 returns the process to step S33. In step S33, the calculating section 42 obtains the λ1 image and the λ2 image output from the camera 22 by performing the image capturing of the camera 22 according to the turning-on of the LED 21a and the LED 21b in which the amount of the irradiation light is adjusted, and then, the same process is performed.

In a case where it is determined in step S38 that the amount of the irradiation light of the LED 21a and the LED 21b are the necessary minimum amount of irradiation light for detection of the skin area, the control section 41 terminates the skin detection adjustment process, and then, the skin detection process in FIG. 7 is performed.

In the above-described skin detection adjustment process, for example, the control section 41 adjusts the gain of the camera 22 so that the average luminance value of the luminance values of the pixels which form the outside light image becomes the luminance value which is half the maximum luminance value obtained by image capturing of the camera 22.

In this case, since the gain is adjusted to be the maximum in the range where the skin area can be detected with high accuracy, specifically, for example, in the range where the calculated average luminance value becomes equal to or smaller than half the maximum luminance value which can be obtained by the outside light image, the control section 41 can extend a detectable distance in which the skin area can be detected while maintaining the detection accuracy of the skin area.

Further, in the skin detection adjustment process, since the amount of the irradiation light of the LED 21a and the LED 21b is reduced in order to obtain the necessary minimum amount of irradiation light for detection of the skin area, it is possible to reduce power necessary for irradiation of the LED 21a and the LED 21b to achieve power saving, while maintaining the detection accuracy of the skin area.

### Modifications in the Second Embodiment

In the skin detection adjustment process, the control section 41 generates the average luminance value of the outside light image on the basis of the histogram of the outside light image from the camera 22, and adjusts the gain of the camera 22 on the basis of the generated average luminance value, but the adjustment method of the gain of the camera 22 is not limited thereto.

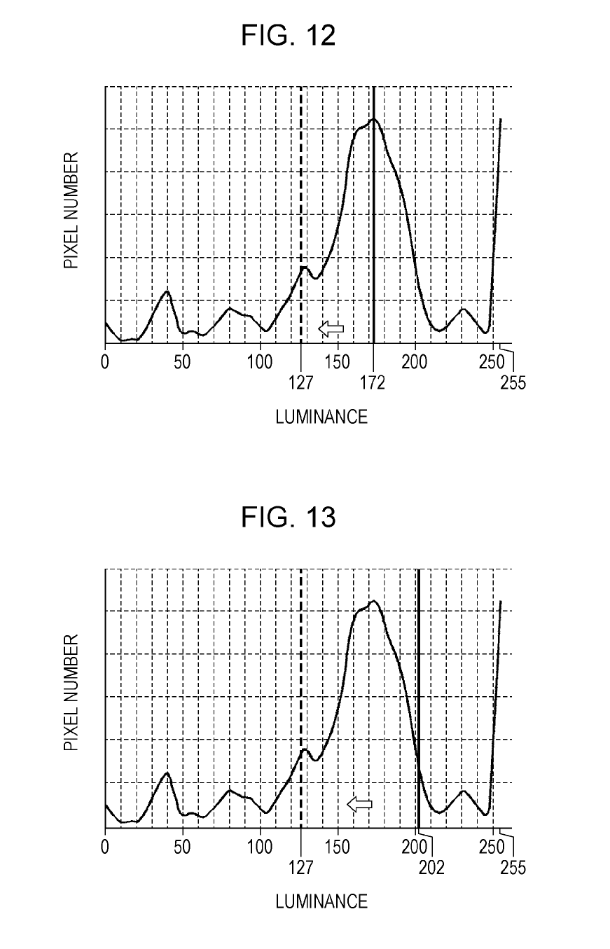

That is, for example, as shown in FIG. 12, the control section 41 may also adjust the gain of the camera 22 so that a peak value (here, 172) indicating the luminance value when the number of the pixels is the maximum, in the histogram generated on the basis of the outside light image from the camera 22, becomes equal to or smaller than half the maximum luminance value which can be taken by the outside light image.

In the case shown in FIG. 12, when a luminance value 255 becomes the peak value, the control section 41 may calculate a peak value except the portion where the luminance value is 255 (saturated), and may adjust the gain of the camera 22 on the basis of the calculated peak value.

Further, for example, as shown in FIG. 13, the control section 41 may adjust the gain of the camera 22 so that a luminance value specified on the basis of a pixel accumulation number indicating the pixel number obtained by a sequential accumulation (addition) from the pixel having a small luminance value, in the histogram generated on the basis of the outside light image from the camera 22, becomes equal to or smaller than half the maximum luminance value which can be taken by the outside light image.

That is, for example, the control section 41 can adjust the gain of the camera 22 so that a luminance value (here, 202) of the pixels accumulated when the pixel accumulation number becomes the pixel number corresponding to 80% of the total pixel number in the histogram becomes equal to or smaller than half the maximum luminance value which can be taken by the outside light image.

Further, in the skin detection adjustment process, the control section 41 adjusts the gain of the camera 22 on the basis of the histogram of the outside light image, but may adjust at least one of the gain of the camera 22, light receiving sensitivity, and light exposure (light receiving) time and the like.

However, in the first embodiment, the R filter, the G filter and the B filter are prepared, and the filter board 71 shown in FIG. 8 is prepared, in order to obtain the transmission characteristics as shown in FIG. 9, but the filter board 71 having the transmission characteristics as shown in FIG. 9 may be configured by using the R filter, the G filter and the B filter of the related art.

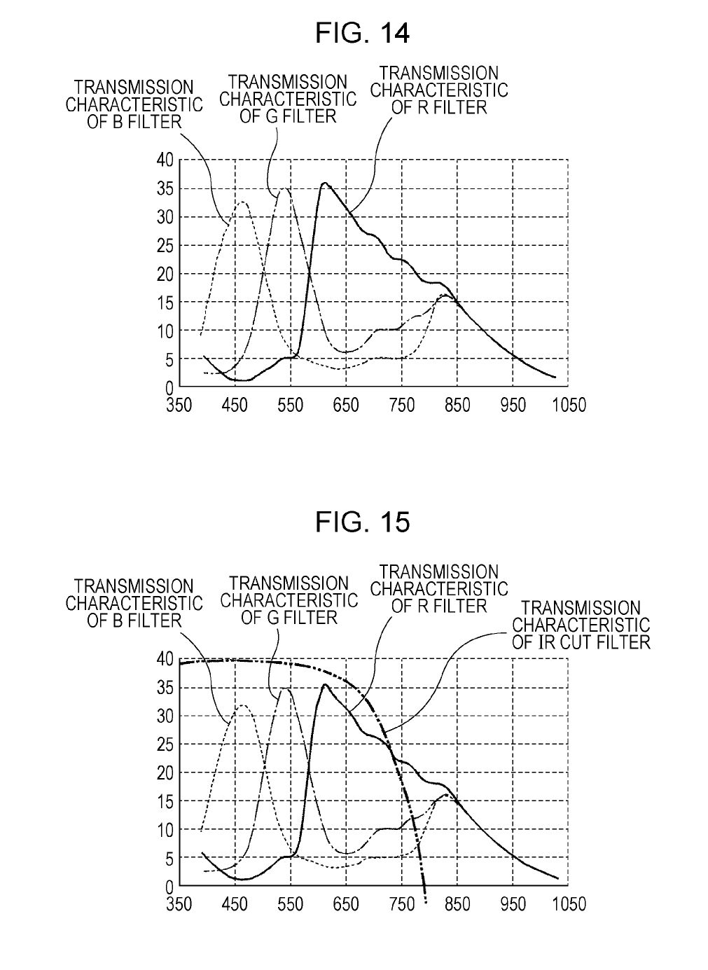

Next, a case where the same filters as the R filter, the G filter and the B filter of the filter board 71 shown in FIG. 9 are prepared using the R filter, the G filter and the B filter of the related art, will be described with reference to FIGS. 14 to 16.

FIG. 14 illustrates an example of the transmission characteristics of the R filter, the G filter, and the B filter of the related art.

FIG. 15 illustrates an example of a wavelength blocked by an IR (infrared) cut filter of the related art. As shown in FIG. 15, the IR cut filter of the related art blocks infrared light (right side with reference to two dotted lines shown in FIG. 15) of a wavelength of about 800 [nm] or longer and transmits light (left side with reference to two dotted lines shown in FIG. 15) of a wavelength which is shorter than about 800 [nm].

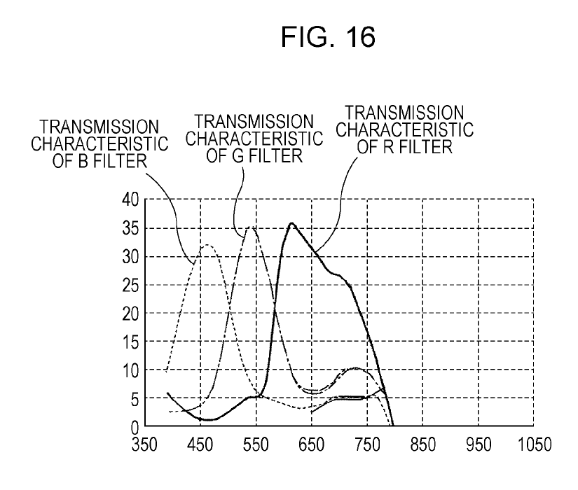

FIG. 16 illustrates an example of transmission characteristics in a case where the IR cut filter of the related art is installed, on each front surface of the R filter, the G filter and the B filter of the related art.

In this way, it is possible to realize the R filter, the G filter and the B filter which have the transmission characteristics as shown in FIG. 16, by installing the IR cut filter of the related art on each front surface of the R filter, G filter and B filter of the related art.

Further, if the IR cut filter of the related art is installed on each front surface of the R filter, G filter and B filter of the related art and the λ1 filter and the λ2 filter are arranged as shown in FIG. 8, it is possible to realize the filter board 71 which has the transmission characteristic shown in FIG. 9.

In this case, since the R filter, the G filter, the B filter and the IR cut filter of the related art are used, it is possible to easily realize the filter board 71, without newly preparing the R filter, the G filter and the B filter in order to obtain the transmission characteristics as shown in FIG. 9.

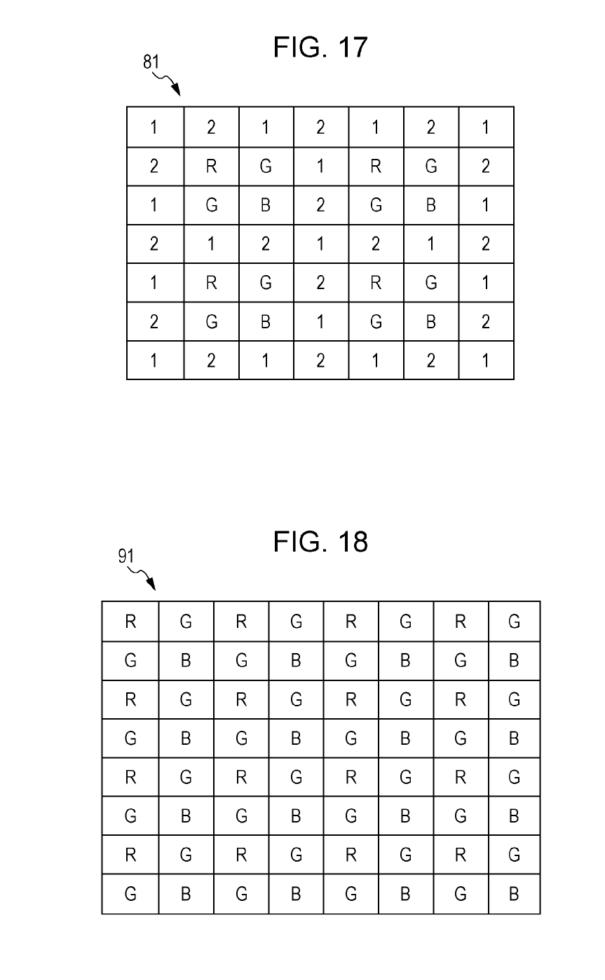

The arrangement of the R filter, the G filter, the B filter, the λ1 filter and the λ2 filter in the filter board is not limited to the arrangement as shown in FIG. 8, and it is possible to prepare a new filter board 81 having an arrangement as shown in FIG. 17, for example.

Further, by using the filter board having the Bayer arrangement of the related art as it is, it is possible to realize a filter board having the transmission characteristics as shown in FIG. 9.

Next, an example in a case where the filter board having the transmission characteristic as shown in FIG. 9 is realized using the filter board of the Bayer arrangement of the related art as it is will be described with reference to FIGS. 18 to 20.

FIG. 18 illustrates an example of a filter board 91 which is arranged in the Bayer arrangement of the related art.

In the filter board 91, the G filters (corresponding to “G” in FIG. 18) are checkerwise arranged, the R filters (corresponding to “R” in FIG. 18) are alternately arranged between the G filters in odd columns, and the B filters (corresponding to “B” in FIG. 18) are alternately arranged between the G filters in even columns.

As four filters including two filters in the horizontal direction and two filters in the vertical direction on the filter board 91, one R filter, one B filter and two G filters are present, and the G filters have one more filter than the R filter and the B filter. This is because a green color corresponding to the G component is relatively difficult for humans to see.

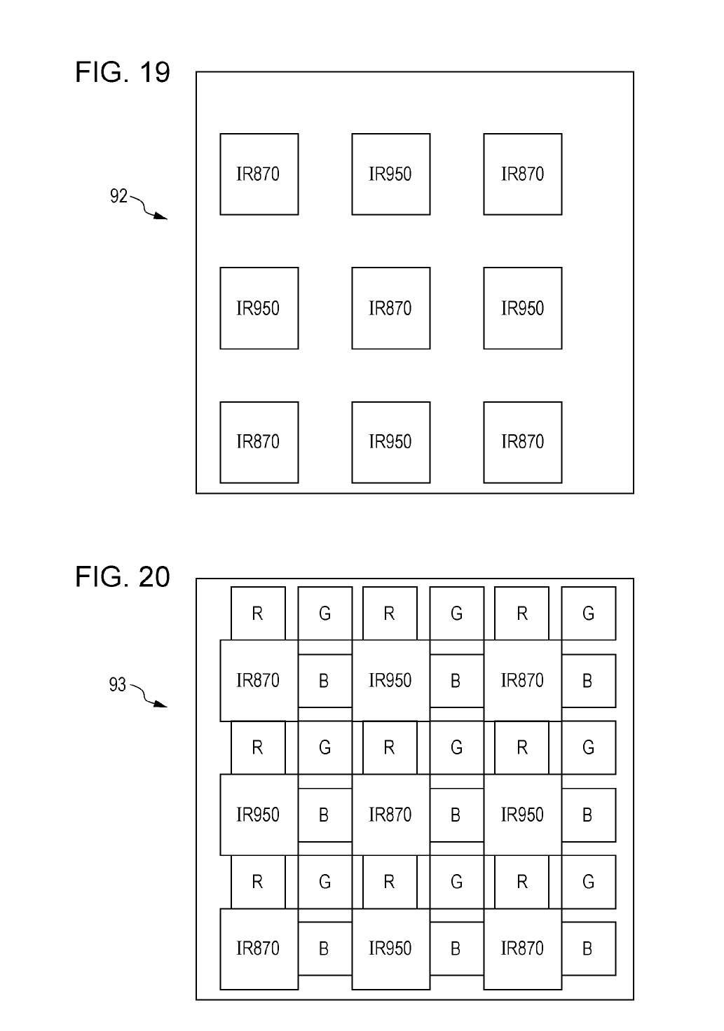

FIG. 19 illustrates an example of an IR cut filter 92 in which the λ1 filter and the λ2 filter are installed.

In the IR cut filter 92, the λ1 filter (IR 870 in FIG. 19) and the λ2 filter (IR 950 in FIG. 19) are checkerwise arranged in the state of being spaced by one pixel, respectively. In the IR cut filter 92, a portion (a gap in FIG. 19) where the λ1 filter and the λ2 filter are not installed functions as the IR cut filter having the transmission (blocking) characteristic as shown in FIG. 15.

A filter board 93 as shown in FIG. 20 is created by covering the front surface of the filter board 91 by the IR cut filter 92. The filter board 93 has the transmission characteristics as shown in FIG. 9.

The information processing system 1 may be miniaturized so as to be installed in an electronic device such as a television set.

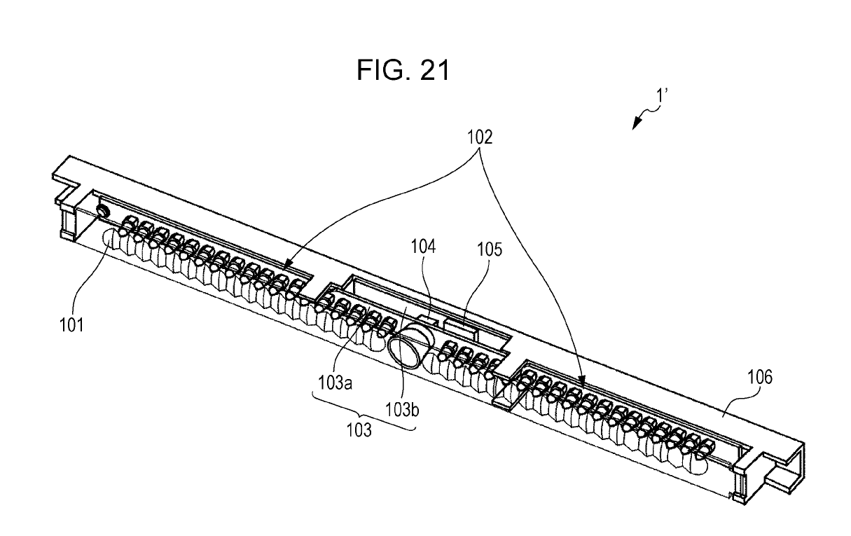

FIG. 21 illustrates an example of a small module 1′ which is the miniaturized information processing system 1.

The small module 1′ includes a lens 101 which corrects light from the LED which forms a light source group 102 (which will be described later) to irradiate the object; the light source group 102 having the plurality of LEDs 21a and LEDs 21b; a substrate 103 including a light source substrate 103a on which the plurality of LEDs 21a and LEDs 21b which forms the light source group 102 is arranged and a process substrate 103b on which a camera 104 and an image processing section 105 (which will be described later) are arranged; the camera 104 which is configured in a similar way to the camera 22 in FIG. 1; the image processing section 105 which is configured in a similar way to the image processing apparatus 23 in FIG. 1; and a support member 106 which supports the lens 101, the light source substrate 103a and the process substrate 103b.

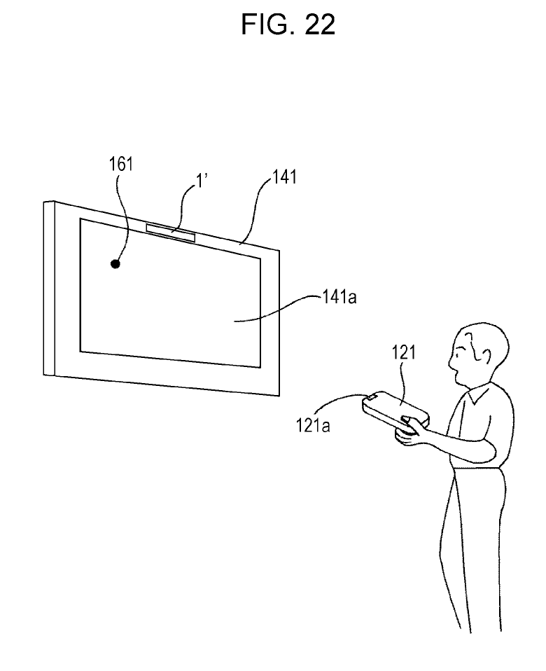

As shown in FIG. 22, for example, the small module 1′ is installed above a display 141a of a television set 141, and performs a process of recognizing the shape or the like of a user's hand present in front of the display 141a of the television set 141, and of changing the sound volume, channels or the like of the television set 141 on the basis of the recognition result.

### 3. Third Embodiment

However, the television set 141 in which the small module 1′ is installed may function as a position detecting apparatus which detects the position of a remote commander 121 for operation of the television set 141, as well as a skin detecting apparatus which detects the skin.

FIG. 22 illustrates a configuration example of the television set 141 which functions as the position detecting apparatus.

The television set 141 is installed with the small module 1′ above the display 141a on which television programs are displayed.

The small module 1′ installed in the television set 141 detects the position of the remote commander 121 operated by the user on the basis of the λ1 image obtained by the image capturing of the object.

That is, for example, in a case where the user moves the remote commander 121 while allowing the light of the wavelength λ1 to be emitted from an LED 121a of the remote commander 121, the small module 1′ image-captures the object, and performs the λ1 interpolation process for the mosaic image obtained by the image capturing, and then detects the position of the LED 121a (position of the remote commander 121) in the λ1 image obtained as a result.

Then, the small module 1′ displays a pointer or the like in a position 161 on the display 141a corresponding to the position of the detected LED 121a.

LED Detection Process Performed by the Television Set 141]

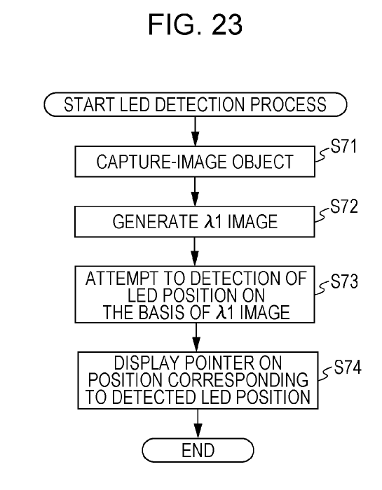

Next, an LED detection process performed by the small module 1′ which is installed in the television set 141 will be described with reference to a flowchart in FIG. 23.

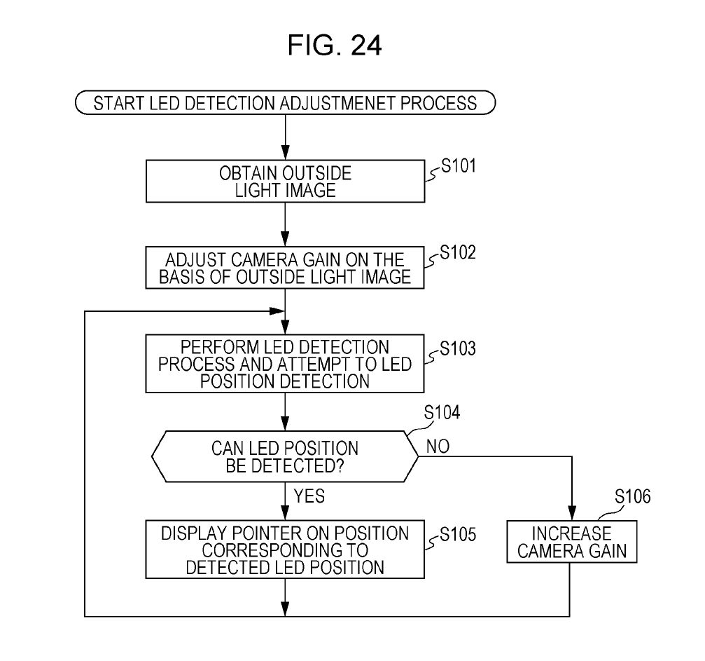

The user moves the remote commander 121, for example, in up, down, right and left directions in a state where the light of wavelength λ1 is emitted from the LED 121a of the remote commander 121, so as to move the pointer on the display 141a. Further, in the LED detection process, the light source group 102 is constantly in a turned-off state. This is the same as the LED detection adjustment process which will be described with reference to FIG. 24.

In step S71, the camera 104 performs image-capturing in a similar way to the camera 22 in FIG. 1, and photoelectrically converts light received by an image sensor of the camera 104 to generate the mosaic image.

In step S72, the camera 104 performs the λ1 interpolation process, on the basis of the generated mosaic image, generates the λ1 image obtained as a result, and then supplies it to the image processing section 105.

In an image-capturing range of the camera 104, the LED 121a is the only light source which emits light of the wavelength λ1.

Accordingly, a pixel value of each pixel which forms an LED display area in which the LED 121a is present, in all areas on the λ1 image, becomes relatively larger than a pixel value of each pixel which forms an area other than the LED display area.

Thus, in step S73, the image processing section 105 attempts to detect the LED display area in which (light from) the LED 121a emitting the light of the wavelength λ1 is displayed, on the λ1 image, on the basis of whether the pixel value of pixel which forms the λ1 image from the camera 104 is equal to or larger than a predetermined LED threshold.

In step S73, the image processing section 105 detects an area in which it is determined that the pixel value is equal to or larger than the LED threshold, in all the areas on the λ1 image from the camera 104, as the LED display area.

In step S74, the image processing section 105 calculates the center of the detected LED display area as the LED position on the λ1 image, and displays the pointer in the position 161 on the display 141a corresponding to the calculated LED position. Thus, the user moves the LED 121a of the remote commander 121 to thereby move the pointer on the display 141a.

As described above, in the LED detection process, the small module 1′ calculates the position of the LED 121a of the remote commander 121 on the basis of the light of the wavelength λ1 emitted from the LED 121a of the remote commander 121. Then, the pointer on the display 141a moves according to the position of the calculated LED 121a.

Thus, the user may use the remote commander 121a as an apparatus for moving the pointer on the display 141a.

However, in a case where the camera 104 is greatly irradiated with the light of the wavelength λ1 from the outside light, an erroneous detection for the LED position may occur due to the light of the wavelength λ1 from the outside light.

LED Detection Adjustment Process Performed by the Television Set 141

Next, the LED detection adjustment process in which the gain of the camera 104 is adjusted according to the outside light and the LED position is detected without any influence of the outside light will be described with reference to a flowchart in FIG. 24.

In this case, it is assumed that in the image sensor of the camera 104, as a filter capable of generating the RGB image, for example, the filter board in FIG. 8 is installed.

In step S101, the camera 104 performs the image-capturing of the object, and obtains the mosaic image obtained by the image capturing. Then, with respect to the obtained mosaic image, the camera 22 performs the RGB interpolation process using the pixel value having any one of the R value, the G value and the B value among the pixel values of the respective pixels which form the mosaic image, and supplies the RGB image obtained as a result, to the image processing section 105 as the outside light image.

In step S102, the image processing section 105 generates a histogram on the basis of the outside light image from the camera 104, and calculates an average luminance value of the luminance values of pixels which form the outside light image on the basis of the generated histogram.

Then, the image processing section 105 adjusts the gain of the camera 104 so that the calculated average luminance value becomes equal to or smaller than half the maximum luminance value which can be taken by the outside light image, on the basis of the calculated average luminance value.

Preferably, the image processing section 105 adjusts the gain of the camera 104 so that the calculated average luminance value becomes the luminance value which is half the maximum luminance value which can be taken by the outside light image.

In step S103, the image processing section 105 attempts to detect the LED position by performing the same process as the LED detection process in FIG. 23.

In step S104, the image processing section 105 proceeds the process to step S105 in a case where the LED position can be detected, for example, displays the pointer in the position 161 on the display 141a of the television set 141, corresponding to the calculated LED position, returns the process to step S103, and then performs the same process.

In step S104, the image processing section 105 proceeds the process to step S106 in a case where the LED position is not detected. Then, in step S106, the image processing section 105 controls the camera 104 so as to adjust the gain of the camera 104 to be larger than the gain which is currently set, and then returns the process to step S103. Then, the image processing section 105 obtains a new λ1 image output by performing the image-capturing through the camera 104 after the gain is adjusted, and then the same process is performed.

As described above, according to the LED detection adjustment process, since the gain of the camera 104 is adjusted on the basis of the outside light image from the camera 104 so that the LED position can be detected irrespective of the light from the outside light, it is possible to detect the LED position with high accuracy, irrespective of the light of the outside light.

In the LED detection process and the LED detection adjustment process, the position of the LED 121a which emits the light of the wavelength λ1 is detected, however in a case where the LED 121a emits the light of the wavelength λ2 instead of the light of the wavelength λ1, the position of the LED 121a can be similarly detected. In this case, the position detection of the LED 121a is performed using the λ2 image instead of the λ1 image.

Further, for example, in a case where a first user who moves a remote commander having a first LED which emits the light of the wavelength λ1 and a second user who moves a remote commander having a second LED which emits the light of the wavelength λ2 are present, the respective positions of the first and second LEDs can be detected in the LED detection process.

Specifically, for example, in a case where the respective positions of the first and second LEDs are detected, the camera 104 supplies the λ1 image obtained by performing the λ1 interpolation process for the generated mosaic image and the λ2 image obtained by performing the λ2 interpolation process for the generated mosaic image, to the image processing section 105, in step S72, in the LED detection process.

Then, in step S73, the image processing section 105 performs the position detection of the first LED on the basis of the λ1 image from the camera 104 and the position detection of the second LED on the basis of the λ2 image from the camera 104.

In step S74, the image processing section 105 moves a corresponding first pointer according to the detected position of the first LED and moves a corresponding second pointer according to the detected position of the second LED.

Further, in a similar way to the LED detection adjustment process, in step S103, the position detection of the first LED device is attempted on the basis of the λ1 image, and the position detection of the second LED device is attempted on the basis of the λ2 image. Then, in step S104, for example, it is determined whether the respective positions of the first LED and second LED can be detected.

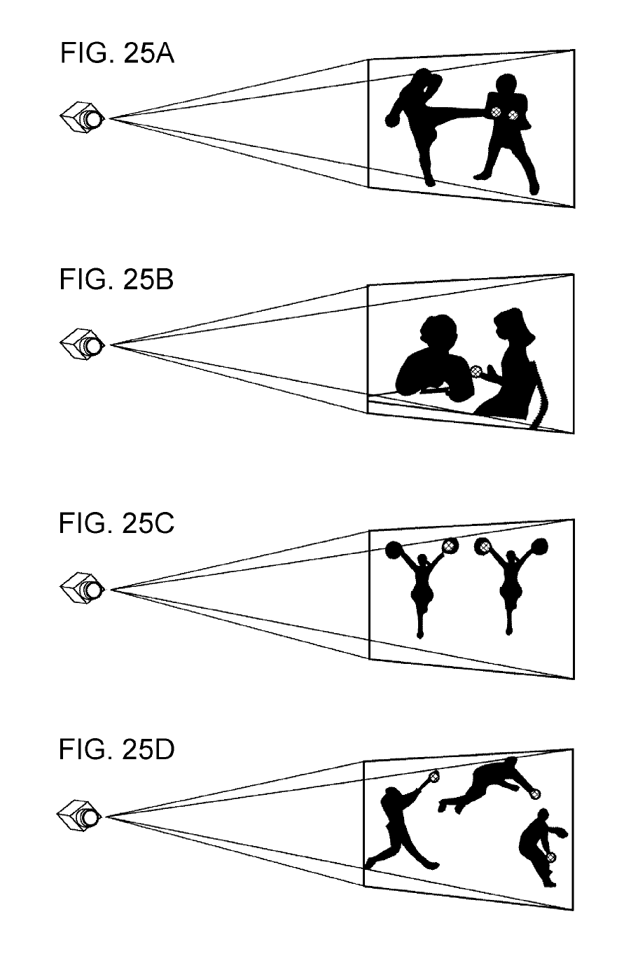

In this way, in a case where the position of the first LED and the position of the second LED can be detected, an image obtained by superposing the first LED position and the second LED position on the RGB image obtained by the RGB interpolation process through the camera 104 may be displayed on the display 141a, for example, as shown in FIGS. 25A to 25D.

Accordingly, for example, it is possible to realize a videogame application by using the television set 141 and the remote commander 121 as described above.

Specifically, for example, as shown in FIG. 25D, in a case where a baseball videogame in which the first user is a fielding side and the second user is an batting side is realized, the first LED position is recognized as a glove position of the fielding side, and the second LED position is recognized as a bat position of the batting side.

Further, for example, if the second LED in addition to the first LED (LED 121a) is installed in the remote commander 121, the posture (for example, whether to grip the operation surface upward or downward, or the like) of the remote commander 121 can be determined according to the relationship between the first and second LED positions detected by the LED detection process or the like.

Accordingly, in this case, since it is possible to determine the operation of reversing pieces of the game of Othello, Japanese chess pieces or the like according to the posture of the remote commander 121, an application of the game of Othello, Japanese chess or the like can be realized using the television set 141 and the remote commander 121.

Further, since it is possible to determine which direction the remote commander 121 rotates in to a change in the posture of the remote commander 121, if the change in the posture of the remote commander 121 matches with an operation of switching the channel of the television set 141, an operation of changing the sound volume, or the like, it is possible to change the channel or the sound volume according to the movement of the remote commander 121.

Further, for example, it is possible to measure the distance to the remote commander 121 (LED 121a) from the small module 1′, on the basis of the detected size of the LED display area using the fact that as the distance to the remote commander 121 (LED 121a) from the small module 1′ is short, the LED display area becomes large.

### Modifications in the Third Embodiment

In the third embodiment, the filter board having at least the λ1 filter and the λ2 filter is used for detection of the LED position, but a λ3 filter which transmits light (hereinafter, referred to as light of a wavelength λ3) in which a peak wavelength of the light emitting spectrum is λ3 (different from λ1 and λ2) may be further installed.

That is, for example, a filter board having N items of the λ1 filter to a λN filter which transmit light of different wavelengths of λ1 to λN may be used.

In this case, if first to N-th LEDs which emit the lights of the wavelengths of λ1 to λN, respectively, are used, the positions of the first to N-th LEDs may be detected in the LED detection process and the LED detection adjustment process.

Accordingly, for example, in a case where an application capable of performing a boxing videogame between the first user and the second user is realized, the first LED device may be gripped by the right hand of the first user, the second LED device may be gripped by the left hand thereof, the third LED device may be gripped by the right hand of the second user, and the fourth LED device may be gripped by the left hand thereof.

Thus, in the small module 1′, it is possible to realize the boxing videogame application by recognizing the positions of the right hand and the left hand of the first user and the positions of the right hand and the left hand of the second user.

Further, in the LED detection process and the LED detection adjustment process, in a case where only the position of the LED 121a which emits the light of the wavelength λ1 is detected, a filter board having at least the λ1 filter may be installed in the image sensor of the camera 104, without the λ2 filter.

As described above, for example, the information processing system 1 performs the skin detection process, and the small module 1′ which is installed in the television set 141 performs the LED detection process, however either of the information processing system 1 and the small module 1′ may perform the skin detection process and the LED detection process. This is similarly applied to the skin detection adjustment process and the LED detection adjustment process.

Specifically, for example, in the information processing system 1, the control section 41 controls the light emitting apparatus 21 and may also perform the LED detection process in a state where the LED 21a and the LED 21b stop emitting light, and the control section 41 may control the light emitting apparatus 21 to perform the skin detection process in a state where the light emission of the LED 21a and the LED 21b are performed.

In this way, in a case where both the skin detection process and the LED detection process can be performed, the information processing system 1 can select either one of the hands-free operation according to the shape or movement of a user's hand and the controller operation through movement of the remote commander (for example, remote commander 121 in FIG. 22), according to user preference.

Further, as described above, in a case where the first user and the second user play a videogame, by appropriately switching the skin detection process and the LED detection process for example, the hands-free operation may be performed in terms of the first user, and the controller operation may be performed in terms of the second user.

### 4. Fourth Embodiment

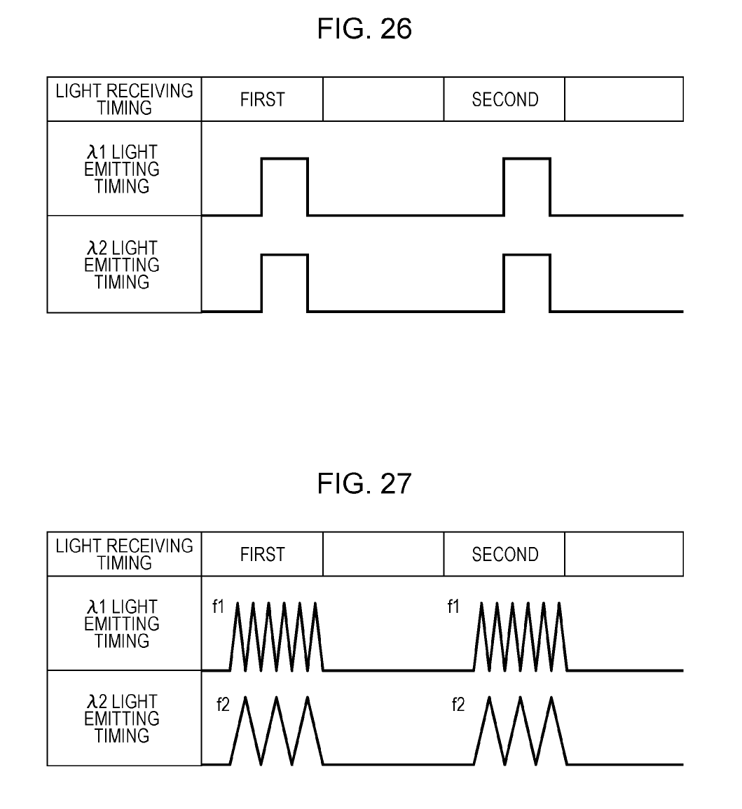

In the above-described first to third embodiments, the image capturing is performed by being irradiated with the light of the wavelength λ1 and the light of the wavelength λ2 at the same time. That is, as shown in FIG. 26, the image capturing is performed by being irradiated with the light of the wavelength λ1 for a predetermined period with a constant luminance, and at the same time, by being irradiated with the light of the wavelength λ2 for a predetermined time with a constant luminance. Further, in the image sensor which forms the camera 22, the λ1 filter or the λ2 filter is installed in each light receiving element, and the λ1 image and the λ2 image are generated by the interpolation process based on the mosaic image output from the image sensor. Accordingly, in the first to third embodiments, it is possible to obtain the λ1 image and the λ2 image by one image capturing. Further, in order to obtain the same images, the light receiving elements for the wavelength λ1 and wavelength λ2 may be separately installed, and a wavelength filter may be installed for each light receiving element.

On the other hand, in the fourth embodiment which will be described herein, the luminance of the light having the wavelength λ1 and the luminance of the light having the wavelength λ2 are alternately changed at different frequencies for simultaneous irradiation, to thereby perform the image capturing.

FIG. 27 illustrates timings of light emission and image-capturing in association with luminance variation according to the fourth embodiment. That is, in the fourth embodiment, the light of the wavelength λ1 is emitted for a predetermined period while alternately changing the luminance at a predetermined frequency f1, and at the same time, the light of the wavelength λ2 is emitted for a predetermined period while alternately changing the luminance at a predetermined frequency f2, to thereby perform the image capturing. The frequencies f1 and f2 are arbitrary, but may be appropriately set so as not to interfere with frequencies of infrared light emitted by the other apparatus (for example, infrared remote controller or the like).

Further, in the image sensor which forms the camera 22, an electric signal obtained by the photoelectric conversion is divided into two parts, each of the two parts passes through a narrowband filter for the frequency f1 or a narrowband filter for the frequency f2, and thus, the λ1 image and the λ2 image are generated. Accordingly, in the fourth embodiment, it is possible to obtain the λ1 image and the λ2 image by one image capturing.

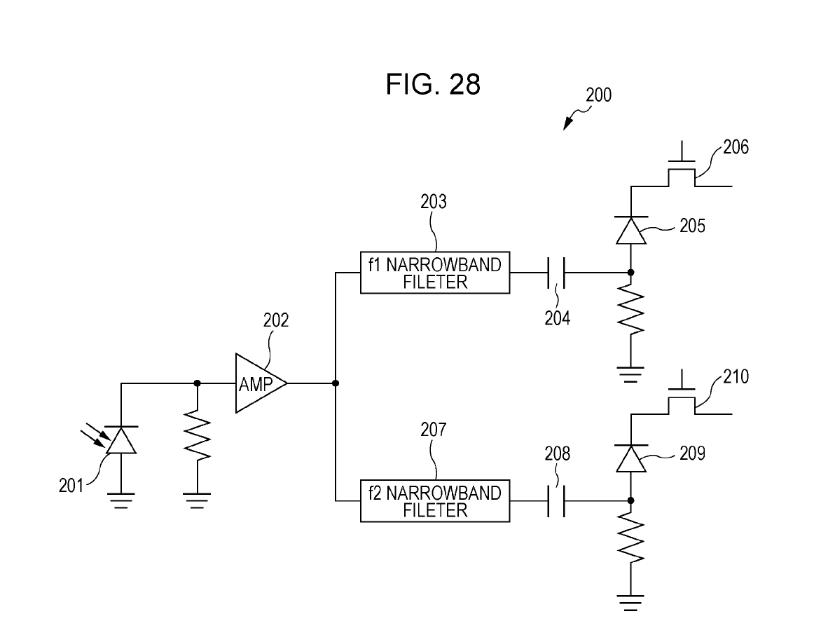

FIG. 28 illustrates a configuration example, corresponding to one pixel of the λ1 image and the λ2 image, of a CMOS image sensor which forms the camera 22 according to the fourth embodiment.

The CMOS image sensor 200 mainly includes a photodiode 201, an amplifier 202, an f1 narrowband filter 203, capacitors 204 and 208, diodes 205 and 209, gates 206 and 210, and an f2 narrowband filter 207.

In the CMOS image sensor 200, an optical image of the object is converted into an electric signal by the photoelectric conversion through the photodiode 201, and the electric signal which is amplified by the amplifier 202 is divided into the f1 narrowband filter 203 and the f2 narrowband filter 207. Further, in the electric signal corresponding to the optical image of the object, only the alternating current component of the frequency f1 passes through the f1 narrowband filter 203 and is AC-combined by the capacitor 204, and electric charge according to signal amplitude is accumulated in the gate 206 through the diode 205. The electric charge accumulated in the gate 206 charges pixels of the λ1 image. Similarly, in the electric signal corresponding to the optical image of the object, only the alternating current component of the frequency f2 passes through the f2 narrowband filter 207 and is AC-combined by the capacitor 208, and electric charge according to signal amplitude is accumulated in the gate 210 through the diode 209. The electric charge accumulated in the gate 210 charges pixels of the λ2 image.

As described above, the f1 narrowband filter 203 and the f2 narrowband filter 207 respectively transmit only the frequency f1 or the frequency f2 of alternating current component. In other words, the direct current component of the electric signal corresponding to the optical image of the object is discarded.

However, generally, irradiation light from the outside light in addition to the irradiation light of the wavelengths λ1 and λ2 which are intentionally emitted is included in the optical image from the object. The outside light due to the sunlight, various illumination light or the like mainly includes a direct current component while including a little alternating current component. Accordingly, the electric charge which passes through the f1 narrowband filter 203 and is accumulated in the gate 206, that is, the λ1 image may be obtained by removing the outside light component. Similarly, the λ2 image may also be obtained by removing the outside light component.

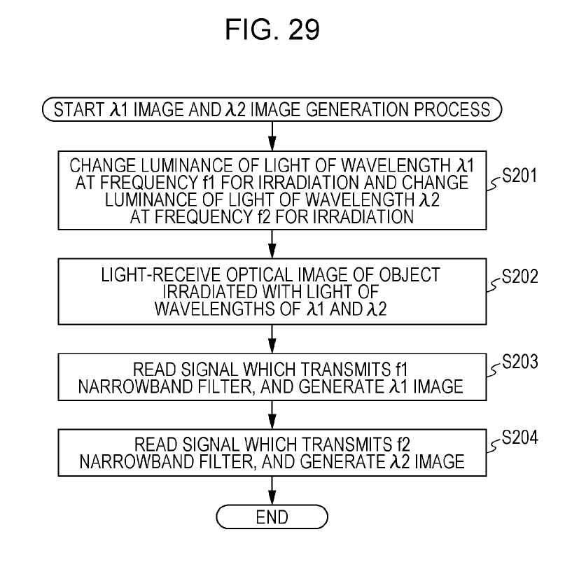

FIG. 29 is a flowchart illustrating a process (hereinafter, referred to as a λ1 and λ2 image generation process) until the λ1 image and the λ2 image are generated according to the fourth embodiment.

In step S201, the light emitting apparatus 21 controls the LED 21a to emit the light of the wavelength λ1 while alternately changing the luminance thereof at the predetermined frequency f1, and controls the LED 21b to emit the light of the wavelength λ2 while alternately changing the luminance at the predetermined frequency f2.

In step S202, the camera 22 image-captures the object which is irradiated with the light of the wavelength λ1 and the wavelength λ2 by the light emitting apparatus 21. That is, the photodiode 201 of the CMOS image sensor 200 which forms the camera 22 converts the optical image of the object into the electric signal. The electric signal is divided into the f1 narrowband filter 203 and the f2 narrowband filter 207 after being amplified by the amplifier 202, and the f1 narrowband filter 203 transmits only the alternating current component of the frequency f1 of the electric signal to the capacitor 204. As a result, the electric charge which charges the pixels of the λ1 image are accumulated in the gate 206. Similarly, in step S204, the f2 narrowband filter 207 transmits only the alternating current component of the frequency f2 of the electric signal to the capacitor 208. As a result, the electric charge which become the pixels of the λ2 image are accumulated in the gate 210.

In step S203, the electric charge which become the pixels of the λ1 image are read out to generate the λ1 image. Similarly, in step S204, the electric charge which become the pixels of the λ2 image are read out to generate the λ1 image.

In this way, the λ1 image and the λ2 image are generated. These processes are performed instead of the processes in step S1 and S2 in the skin detection process according to the first embodiment. Since processes thereafter are the same as in step S3 and thereafter in the above-described skin detection process, its description will be omitted.

In the λ1 image and the λ2 image obtained according to the fourth embodiment, since the outside light component (direct current component) is removed without the pixel interpolation process, and the position of the object is not misaligned, it is possible to detect the skin with high accuracy, even in the case where there is movement in the object.

### 5. Fifth Embodiment

In a fifth embodiment, the light having the wavelength λ1 and the light having the wavelength λ2 are alternately emitted while alternately changing the luminances thereof at the same frequency, to perform image capturing.

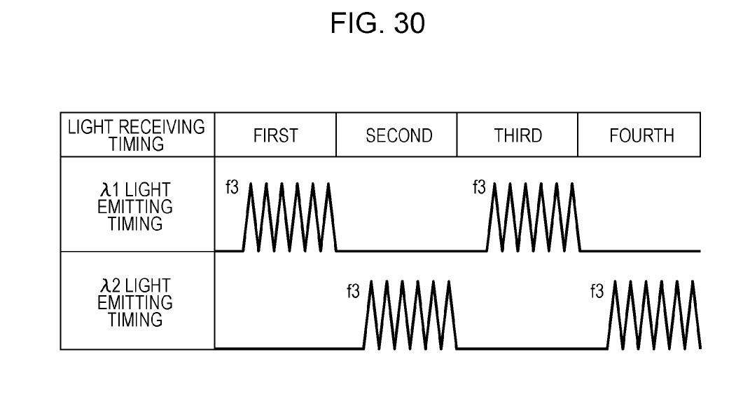

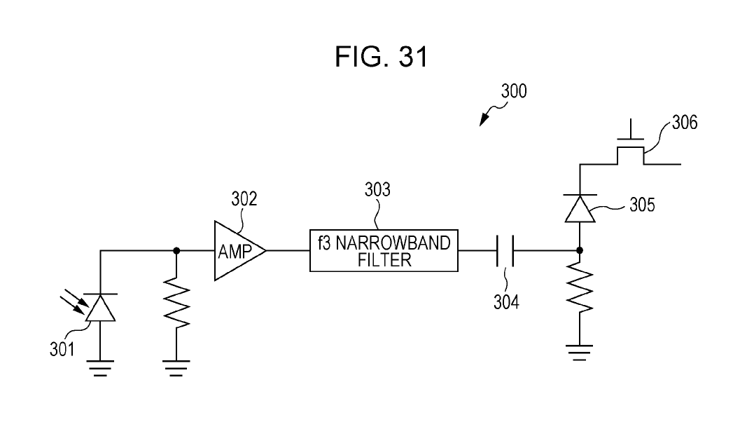

FIG. 30 illustrates timings of irradiation and image-capturing in association with luminance variation according to the fifth embodiment. That is, in the fifth embodiment, the light of the wavelength λ1 is emitted for a predetermined period while alternately changing the luminance thereof at a predetermined frequency f3, to thereby perform the image capturing, and then, the light of the wavelength λ2 is emitted for a predetermined period while alternately changing the luminance thereof at a predetermined frequency f3, to thereby perform image capturing.

Further, in the image sensor which forms the camera 22, the electric signal obtained by the photoelectric conversion passes through a narrowband filter for the frequency f3, to thereby alternately generate the λ1 image and the λ2 image. Accordingly, in the fifth embodiment, it is possible to obtain the λ1 image and the λ2 image by the image capturing two times.

FIG. 28 illustrates a configuration example, corresponding to one pixel of the λ1 image and the λ2 image, of the CMOS image sensor which forms the camera 22 according to the fifth embodiment.

The CMOS image sensor 300 mainly includes a photodiode 301, an amplifier 302, an f3 narrowband filter 303, a capacitor 304, a diode 305 and a gate 306. The f3 narrowband filter 303 may be formed of one of hardware and software.

In the CMOS image sensor 300, the optical image of the object is converted by the photoelectric conversion through the photodiode 301. In the electric signal which is amplified by the amplifier 302, only the direct current component of the frequency f3 passes through the f3 narrowband filter 303, and its electric charge is accumulated in the gate 306. Accordingly, the electric charge accumulated in the gate 306 become pixels of the λ1 image when being irradiated with the light of the wavelength λ1, and the electric charge accumulated in the gate 306 become pixels of the λ2 image when being irradiated with the light of the wavelength λ2.

The f3 narrowband filter 303 transmits only the alternating current component of the f3 frequency. In other words, the direct current component of the electric signal corresponding to the optical image of the object is discarded. Accordingly, the electric charge which passes through the f3 narrowband filter 303 and are accumulated in the gate 306, that is, the λ1 image and the λ2 image can be obtained by removing the outside light component.

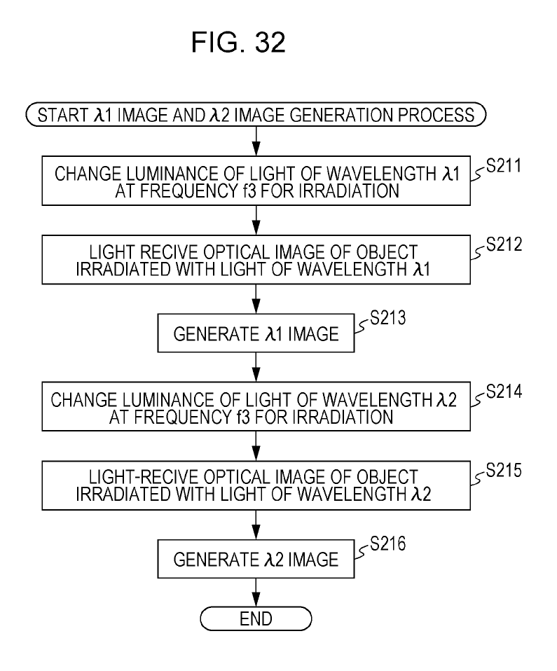

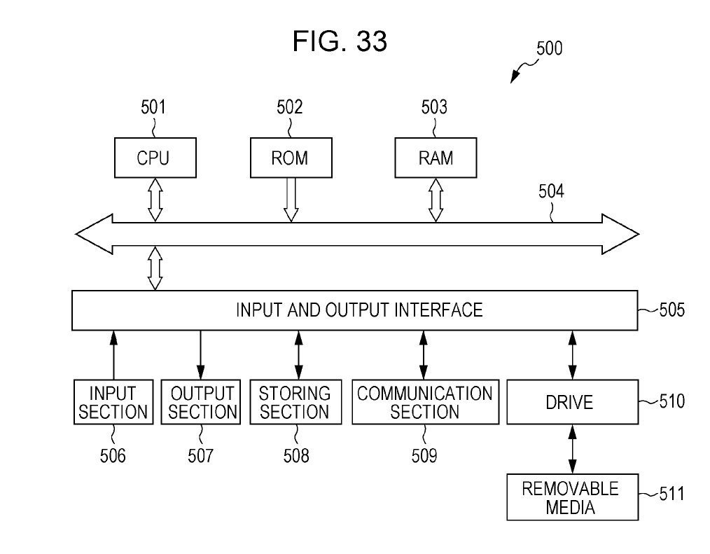

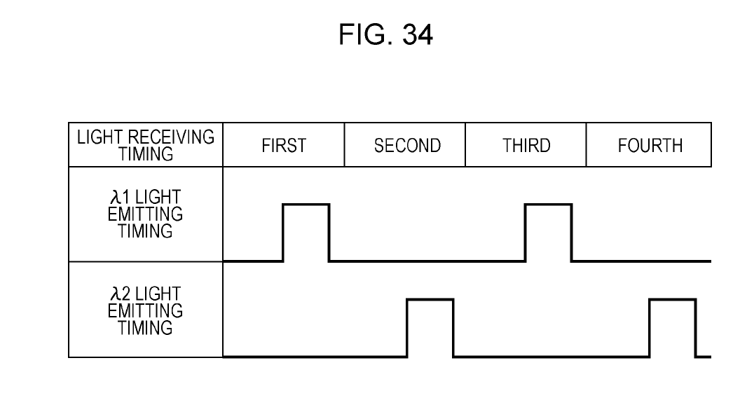

FIG. 32 is a flowchart illustrating the λ1 and λ2 image generation process according to the fifth embodiment.

In step S211, the light emitting apparatus 21 controls the LED 21a to emit the light of the wavelength λ1 while alternately changing the luminance thereof at the predetermined frequency f3. In step S212, the camera 22 image-captures the object which is irradiated with the light of the wavelength λ1 by the light emitting apparatus 21. That is, the photodiode 301 of the CMOS image sensor 300 which forms the camera 22 converts the optical image of the object into the electric signal. The electric signal is input to the f3 narrowband filter 303 after being amplified by the amplifier 302, and the f3 narrowband filter 303 transmits only the alternating current component of the frequency f3 of the electric signal to the capacitor 304. As a result, the electric charge which charges the pixels of the λ1 image is accumulated in the gate 306.

In step S213, the electric charge which charges the pixels of the λ1 image is read out to generate the λ1 image.

In step S214, the light emitting apparatus 21 controls the LED 21b to emit the light of the wavelength λ2 while alternately changing the luminance thereof at the predetermined frequency f3. In step S215, the camera 22 image-captures the object which is irradiated with the light of the wavelength λ2 by the light emitting apparatus 21. That is, the photodiode 301 of the CMOS image sensor 300 which forms the camera 22 converts the optical image of the object into the electric signal. The electric signal is input to the f3 narrowband filter 303 after being amplified by the amplifier 302.

In step S216, the f3 narrowband filter 303 transmits only the alternating current component of the frequency f3 of the electric signal to the capacitor 304. As a result, the electric charge which charges the pixels of the λ2 image is accumulated in the gate 306.

As described above, the λ1 image and the λ2 image are generated. These processes are performed instead of the processes in step S1 and S2 in the skin detection process according to the first embodiment. Since processes thereafter are the same as in step S3 and thereafter in the above-described skin detection process, its description will be omitted.

In the λ1 image and the λ2 image obtained according to the fifth embodiment, since the outside light component (direct current component) is removed without the pixel interpolation process, it is possible to detect the skin of an object with high accuracy.

However, the series of processes as described above may be performed by special hardware, or may be performed by software. In a case where the series of processes is performed by software, a program which forms the software is installed, from a recording medium, in a so-called embedded computer, or a general-purpose computer or the like which is installed with a variety of programs to perform a variety of functions, for example.

Configuration Example of a Computer

FIG. 33 illustrates a configuration example of a computer which executes the series of processes as described above by programs.

In a computer 500, a CPU 501 executes a variety of processes according to programs stored in a ROM 502 and a storing section 508. In a RAM 503, programs, data or the like to be executed by the CPU 501 are appropriately stored. The CPU 501, the ROM 502 and the RAM 503 are connected to each other through a bus 504.

Further, an input and output interface 505 is connected to the CPU 501 through the bus 504. An input section 506 including a keyboard, a mouse, a microphone or the like, and an output section 507 including a display, a speaker or the like are connected to the input and output interface 505. The CPU 501 performs a variety of processes according to commands input from the input section 506. Then, the CPU 501 outputs the process result to the output section 507.

The storing section 508 which is connected to the input and output interface 505 includes a hard disk, for example, and stores programs to be executed by the CPU 501 or a variety of data. A communication section 509 performs communication with external apparatuses through a network such as a local area network, the Internet or the like. Further, programs may be obtained through the communication section 509, and may be stored in the storing section 508.

When a removable media 511 such as a magnetic disk, an optical disc, a magneto-optical disc, a semiconductor memory or the like is installed, a drive 510 connected to the input and output interface 505 drives the removable media 511, and obtains programs, data or the like recorded thereon. The obtained programs or data are transmitted to and stored in the storing section 508 as necessary.

The recording medium which records (stores) the programs which are installed in the computer and can be executed by the computer includes the removable media 511 which is a package media including a magnetic disk, an optical disc, a magneto-optical disc, a semiconductor memory or the like, the ROM 502 in which the programs are temporarily or permanently stored, a hard disk which forms the storing section 508, or the like. Recording of the programs to the recording medium is performed by a wired or wireless communication medium called a local area network, the Internet, digital satellite broadcasting, through the communication section 509 which is an interface such as a router, a modem or the like, as necessary.

In this description, the steps corresponding to the series of processes as described above may be performed in a time series manner, or may be performed in parallel or individually.

Further, in this description, the system refers to an entire system including a plurality of devices or apparatuses.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An image processing apparatus which detects a skin area indicating human skin from an image, comprising:
an irradiating section which irradiates an object with light having a first wavelength and a light of a second wavelength which is different from the first wavelength;
a first generating section which is installed with an image sensor at least having a first light receiving element which receives the light having the first wavelength and a second light receiving element which receives the light having the second wavelength, and generates a first mosaic image on the basis of reflected light from the object when the object is irradiated with the lights of the first and second wavelengths, which are incident to the image sensor;
a second generating section which generates a first image obtained by a first interpolation process based on a pixel value of a pixel corresponding to the first light receiving element and a second image obtained by a second interpolation process based on a pixel value of a pixel corresponding to the second light receiving element, in respective pixels which form the first mosaic image; and
a detecting section which detects the skin area on the basis of the first and second images.

2. The image processing apparatus according to claim 1,
wherein the first generating section generates the first mosaic image on the basis of the reflected light from the object which is incident to the image sensor including the first and second light receiving elements, a third light receiving element which receives an R (red) component, a fourth light receiving element which receives a G (green) component and a fifth light receiving element which receives a B (blue) component.

3. The image processing apparatus according to claim 2,
wherein the first generating section generates a second mosaic image on the basis of the reflected light from the object when the object is not irradiated with the lights of the first and second wavelengths, which are incident to the image sensor,
wherein the second generating section generates an RGB image obtained by a third interpolation process based on a pixel value of a pixel corresponding to each of the third to fifth light receiving elements, in respective pixels which form the second mosaic image, and
wherein the image processing apparatus further comprises an adjusting section which adjusts parameters of the first generating section in a range where a skin detectable condition for detecting the skin area is satisfied, on the basis of the RGB image.

4. The image processing apparatus according to claim 3,
wherein the first generating section generates the first mosaic image by image-capturing the object according to a predetermined parameter, and
wherein the adjusting section adjusts the parameters of the first generating section in a range where the skin detectable condition that one of a luminance value of a pixel which forms the RGB image and a calculated value calculated on the basis of the luminance value become equal to or smaller than half a maximum luminance value which can be taken by the RGB image is satisfied.

5. The image processing apparatus according to claim 1, further comprising:
a first incident restriction section which restricts incidence of light having wavelengths other than the first wavelength and transmits the light of the first wavelength; and
a second incident restriction section which restricts incidence of lights having wavelengths other than the second wavelength and transmits the light of the second wavelength,
wherein the first generating section is installed with the image sensor which at least has the first light receiving element which receives the light of the first wavelength obtained through the first incident restriction section and the second light receiving element which receives the light of the second wavelength obtained through the second incident restriction section therein.

6. The image processing apparatus according to claim 1,
wherein the first generating section generates a second mosaic image on the basis of the reflected light from the object when the object is not irradiated with the light of the first and second wavelengths, which are incident to the image sensor,
wherein the second generating section generates a third image obtained by a fourth interpolation process based on a pixel value of a pixel corresponding to the first light receiving element, in respective pixels which form the second mosaic image, and
wherein the detecting section detects a predetermined area including pixels in which a pixel value of each pixel which forms the third image is equal to or larger than a predetermined threshold, among all areas in the third image.

7. The image processing apparatus according to claim 6, further comprising a control section which controls irradiation of the irradiating section,
wherein the detecting section detects the skin area on the basis of the first and second images generated by the second generating section in a case where the irradiation of the irradiating section is performed under the control of the control section, and detects the predetermined area on the basis of the third image generated by the second generating section in a case where the irradiation of the irradiating section is not performed under the control of the control section.

8. An image processing method in an image processing apparatus which includes an irradiating section, a first generating section which is installed with an image sensor at least having a first light receiving element which receives a light having a first wavelength and a second light receiving element which receives a light having a second wavelength which is different from the first wavelength, a second generating section, and a detecting section, and detects a skin area indicating human skin from an image, comprising:
irradiating an object with the light of the first wavelength and the light of the second wavelength, by the irradiation section;
generating a first mosaic image on the basis of reflected light from the object when the object is irradiated with the lights of the first and second wavelengths, which are incident to the image sensor, by the first generating section;
generating a first image obtained by a first interpolation process based on a pixel value of a pixel corresponding to the first light receiving element and a second image obtained by a second interpolation process based on a pixel value of a pixel corresponding to the second light receiving element, in respective pixels which form the first mosaic image, by the second generating section; and
detecting the skin area on the basis of the first and second images by the detecting section.

9. A program which allows a computer controlling an image processing apparatus which includes an irradiating section which irradiates an object with a light having a first wavelength and a light of a second wavelength which is different from the first wavelength and a first generating section which is installed with an image sensor at least having a first light receiving element which receives the light having the first wavelength and a second light receiving element which receives the light having the second wavelength, and generates a first mosaic image on the basis of a reflected light from the object when the object is irradiated with the lights of the first and second wavelengths, which are incident to the image sensor, the image processing apparatus detecting a skin area indicating human skin from an image, to have functions comprising:
a second generating section which generates a first image obtained by a first interpolation process based on a pixel value of a pixel corresponding to the first light receiving element and a second image obtained by a second interpolation process based on a pixel value of a pixel corresponding to the second light receiving element, in respective pixels which form the first mosaic image; and
a detecting section which detects the skin area on the basis of the first and second images.

10. An electronic apparatus which detects a skin area indicating human skin from an image, comprising:
an irradiating section which irradiates an object with a light having a first wavelength and a light of a second wavelength which is different from the first wavelength;
a first generating section which is installed with an image sensor at least having a first light receiving element which receives the light having the first wavelength and a second light receiving element which receives the light having the second wavelength, and generates a first mosaic image on the basis of a reflected light from the object when the object is irradiated with the lights of the first and second wavelengths, which are incident to the image sensor;
a second generating section which generates a first image obtained by a first interpolation process based on a pixel value of a pixel corresponding to the first light receiving element and a second image obtained by a second interpolation process based on a pixel value of a pixel corresponding to the second light receiving element, in respective pixels which form the first mosaic image;
a detecting section which detects the skin area on the basis of the first and second images; and
an executing section which executes a process according to the detected skin area.

11. An image processing apparatus which detects a skin area of human skin from an image, comprising:
an irradiating section which irradiates an object with a light having a first wavelength and a light of a second wavelength which is different from the first wavelength;
an image capturing section which image-captures the object, and generates a first image based on the light of the first wavelength and a second image based on the light of the second wavelength; and
a detecting section which detects the skin area on the basis of the generated first and second images,
wherein the irradiating section changes the luminance of the light of the first wavelength and the luminance of the light of the second wavelength according to a predetermined frequency to irradiate the object, and
wherein the image capturing section extracts a component, corresponding to the predetermined frequency, of an electric signal obtained by photoelectrically converting an optical image of the object, to generate the first and second images.

12. The image processing apparatus according to claim 11,
wherein the irradiating section alternately changes the luminance of the light of the first wavelength and the luminance of the light of the second wavelength according to the predetermined frequency to irradiate the object, and
wherein the image capturing section extracts an alternating current component, corresponding to the predetermined frequency, of the electric signal obtained by photoelectrically converting the optical image of the object, to generate the first and second images.

13. The image processing apparatus according to claim 12,
wherein the irradiating section performs a process of alternately changing the luminance of the light of the first wavelength according to a first frequency to irradiate the object and a process of alternately changing the luminance of the light of the second wavelength according to a second frequency which is different from the first frequency to irradiate the object, at the same time, and
wherein the image capturing section generates the first image by extracting the alternating current component, corresponding to the first frequency, of the electric signal obtained by photoelectrically converting the optical image of the object in the state of being irradiated with the lights of the first and second wavelengths, and generates the second image by extracting the alternating current component, corresponding to the second frequency, of the electric signal obtained by photoelectrically converting the optical image of the object.

14. The image processing apparatus according to claim 12,
wherein the irradiating section alternately performs a process of alternately changing the luminance of the light of the first wavelength according to a third frequency to irradiate the object and a process of alternately changing the luminance of the light of the second wavelength according to the third frequency to irradiate the object, and
wherein the image capturing section generates the first image by extracting the alternating current component, corresponding to the third frequency, of the electric signal obtained by photoelectrically converting the optical image of the object in the state of being irradiated with the light of the first wavelength, and generates the second image by extracting the alternating current component, corresponding to the third frequency, of the electric signal obtained by photoelectrically converting the optical image of the object in the state of being irradiated with the light of the second wavelength.

15. An image processing method in an image processing apparatus which includes an irradiating section which irradiates an object with lights of a first wavelength and a second wavelength which is different from the first wavelength, an image capturing section which image-captures the object, and generates a first image based on the light of the first wavelength and a second image based on the light of the second wavelength, and a detecting section which detects a skin area on the basis of the generated first and second images, and detects the skin area indicating human skin from an image, comprising:
changing the luminance of the light of the first wavelength and the luminance of the light of the second wavelength according to a predetermined frequency to irradiate the object, by the irradiating section; and
generating the first and second image by extracting a component, corresponding to the predetermined frequency, of an electric signal obtained by photoelectrically converting an optical image of the object, by the image capturing section.

16. A program for controlling an image processing apparatus which includes an irradiating section which irradiates an object with a light having a first wavelength and a light of a second wavelength which is different from the first wavelength; an image capturing section which image-captures the object, and generates a first image based on the light of the first wavelength and a second image based on the light of the second wavelength; and a detecting section which detects a skin area on the basis of the generated first and second images, and detects the skin area of human skin from an image,
the program allowing a computer of the image processing apparatus to execute processes comprising:
changing the luminance of the light of the first wavelength and the luminance of the light of the second wavelength according to a predetermined frequency to irradiate the object, by controlling the irradiating section, and
extracting a component, corresponding to the predetermined frequency, of an electric signal obtained by photoelectrically converting an optical image of the object, to generate the first and second images, by controlling the image capturing section.

17. An electronic apparatus which detects a skin area indicating human skin from an image, comprising:
an irradiating section which irradiates an object with a light having a first wavelength and a light of a second wavelength which is different from the first wavelength;
an image capturing section which image-captures the object, and generates a first image based on the light of the first wavelength and a second image based on the light of the second wavelength;
a detecting section which detects the skin area on the basis of the generated first and second images, and
an executing section which executes a process according to the detected skin area,
wherein the irradiating section changes the luminance of the light of the first wavelength and the luminance of the light of the second wavelength according to a predetermined frequency to irradiate the object, and
wherein the image capturing section extracts a component, corresponding to the predetermined frequency, of the electric signal obtained by photoelectrically converting the optical image of the object, to generate the first and second images.
